(19) United States
(12) Patent Application Publication
(10) Pub. No.: US 2026/0142987 A1
(43) Pub. Date: May 21, 2026

(54) SECURITY ACTION BASED ON CROSS-TENANT SECURITY THREAT ANALYSIS USING A MULTI-TENANT IDENTIFIER

(71) Applicant: Microsoft Technology Licensing, LLC, Redmond, WA (US)

(72) Inventors: Narayan NEVREKAR, Sammamish, WA (US); Vishal Kumar SESHAGIRIRAO ANIL, Snoqualmie, WA (US)

(21) Appl. No.: 18/949,931

(22) Filed: Nov. 15, 2024

(51) Int. Cl. H04L 9/40

(52) U.S. Cl. CPC H04L 63/1425; H04L 63/1416

(57) ABSTRACT

Techniques are described herein that are capable of performing a security action based on cross-tenant security threat analysis using a multi-tenant identifier. First and second security data are gathered from first and second resources in first and second security-bounded tenants and stored in a tenant-shared store using first and second tenant-specific identifiers. A cross-tenant security threat analysis is performed with regard to the first and second security-bounded tenants by using a multi-tenant identifier to obtain multi-tenant permission to access the first security data and the second security data in the tenant-shared store. As a result of the cross-tenant security threat analysis indicating a security threat with regard to the first security-bounded tenant and/or the second security-bounded tenant, execution of an instruction is triggered, which causes a security action to be performed with regard to the first security-bounded tenant and/or the second security-bounded tenant.

### BACKGROUND

A security threat is an occurrence (e.g., an action or an absence of action) that is capable of causing or facilitating harm to a system and/or a user of the system. Security threat analysis is an analysis of information regarding a system and/or a user of the system to identify, assess, and/or address (e.g., contain, mitigate, or remediate) a security threat to the system and/or the user. The system may include multiple tenants. A tenant includes an identity (e.g., a user) and/or a resource that is associated with an instance of a program and/or a service. Examples of a program include but are not limited to a software program and an application (e.g., a software application). Examples of a service include but are not limited to a software service, a product (e.g., a software product), a tool (e.g., a software tool), a platform (e.g., a software platform), and a digital service. However, conventional security threat analysis techniques analyze information regarding one tenant at a time. Accordingly, a security analyst often switches between tenants in a multi-tenant system manually to investigate a security incident in an effort to determine whether multiple tenants are negatively impacted by the security incident.

Configuring a system to include multiple tenants may be relatively complex and may require coordinated actions between tenant administrators who are tasked with managing security of the respective tenants. Configuring the system to include multiple tenants therefore may be relatively slow, error-prone, and/or inefficient. Even if the system is configured to include multiple tenants, conventional security threat techniques typically are unable to discover all of the tenants. Accordingly, the conventional security threat techniques may be unable to monitor and manage information from multiple tenants in the system and/or to find gaps or inconsistencies in security policies, configurations, or controls of the system. Without the ability to monitor and manage information from multiple tenants, the conventional security threat techniques are unable to perform cross-tenant correlation and analysis of security events, alerts, and incidents.

### SUMMARY

It may be desirable to perform cross-tenant security threat analysis with regard to multiple security-bounded tenants using a multi-tenant identifier associated with a unified security account to enable detection of a cross-tenant security threat. By enabling the detection of the cross-tenant security threat, security of one or more of the security-bounded tenants (e.g., a system that includes the security-bounded tenants) may be increased. For instance, using the multi-tenant identifier to perform the cross-tenant security threat analysis may enable (e.g., cause) the cross-tenant security threat to be detected without a need for a security analyst to switch between the security-bounded tenants manually to do so. For example, using the multi-tenant identifier to perform the cross-tenant security threat analysis may enable the cross-tenant security threat to be automatically detected. By using the multi-tenant identifier, all the security-bounded tenants in the system may be discovered. Discovering all the security-bounded tenants in the system may enable information from the security-bounded tenants to be monitored and managed; machine resources that are unnecessarily duplicative across multiple tenants to be identified and addressed; gaps or inconsistencies in security policies, configurations, or controls of the system to be found; and/or cross-tenant correlation and analysis of security events, alerts, and incidents to be performed.

Various approaches are described herein for, among other things, performing a security action based on (e.g., based at least on) cross-tenant security threat analysis using a multi-tenant identifier. In an example approach, first security data is gathered from a first resource in a first security-bounded tenant, and second security data is gathered from a second resource in a second security-bounded tenant. The first security data is stored in a tenant-shared store associated with a unified security account using a first tenant-specific identifier associated with the first security-bounded tenant. The second security data is stored in the tenant-shared store using a second tenant-specific identifier associated with the second security-bounded tenant. A cross-tenant security threat analysis is performed with regard to the first security-bounded tenant and the second security-bounded tenant by using a multi-tenant identifier associated with the unified security account to obtain multi-tenant permission to access the first security data and the second security data in the tenant-shared store. As a result of the cross-tenant security threat analysis indicating a security threat with regard to the first security-bounded tenant and/or the second security-bounded tenant, execution of an instruction is triggered. The execution of the instruction causes a security action to be performed with regard to the first security-bounded tenant and/or the second security-bounded tenant.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

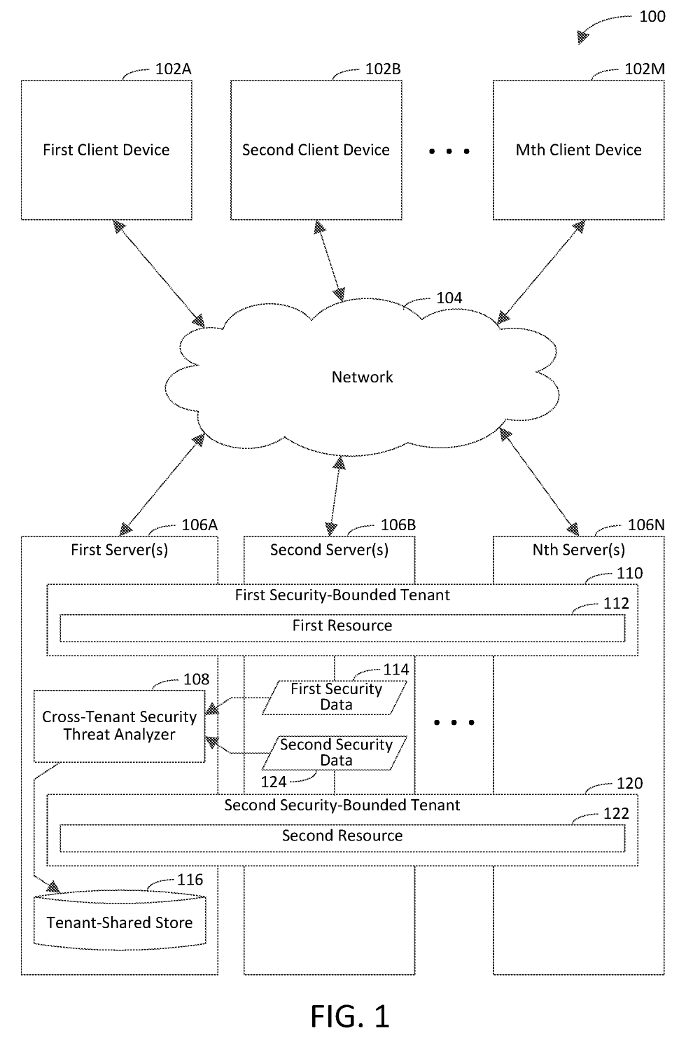

FIG. 1 is a block diagram of an example cross-tenant security threat analysis system in accordance with an embodiment.

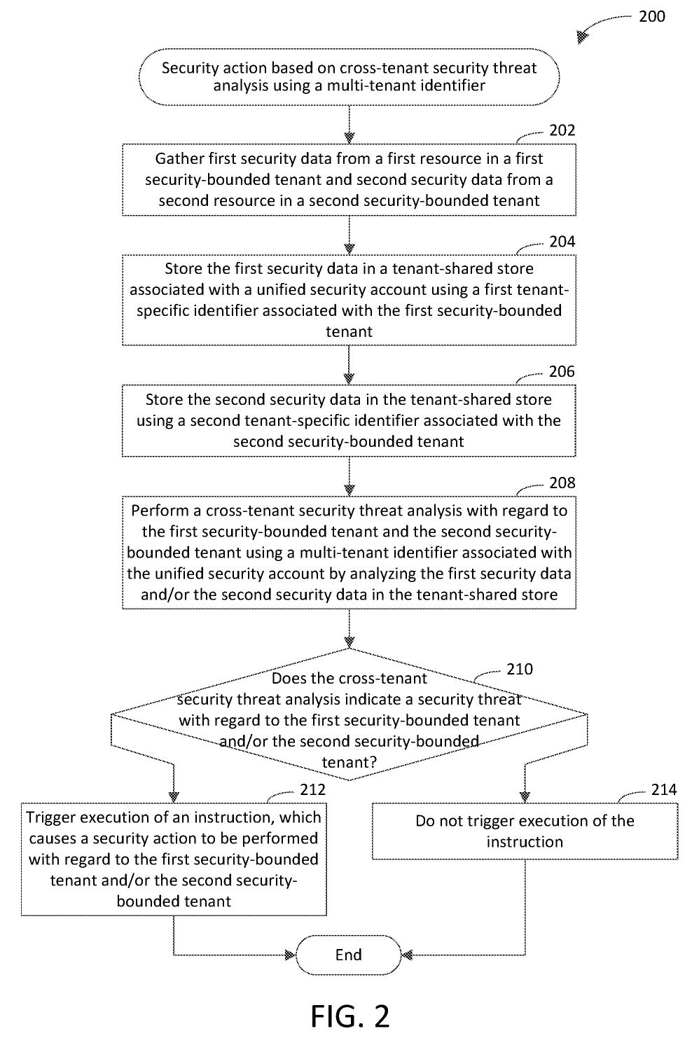

FIGS. 2-7 depict flowcharts of example methods for performing a security action based on cross-tenant security threat analysis using a multi-tenant identifier in accordance with embodiments.

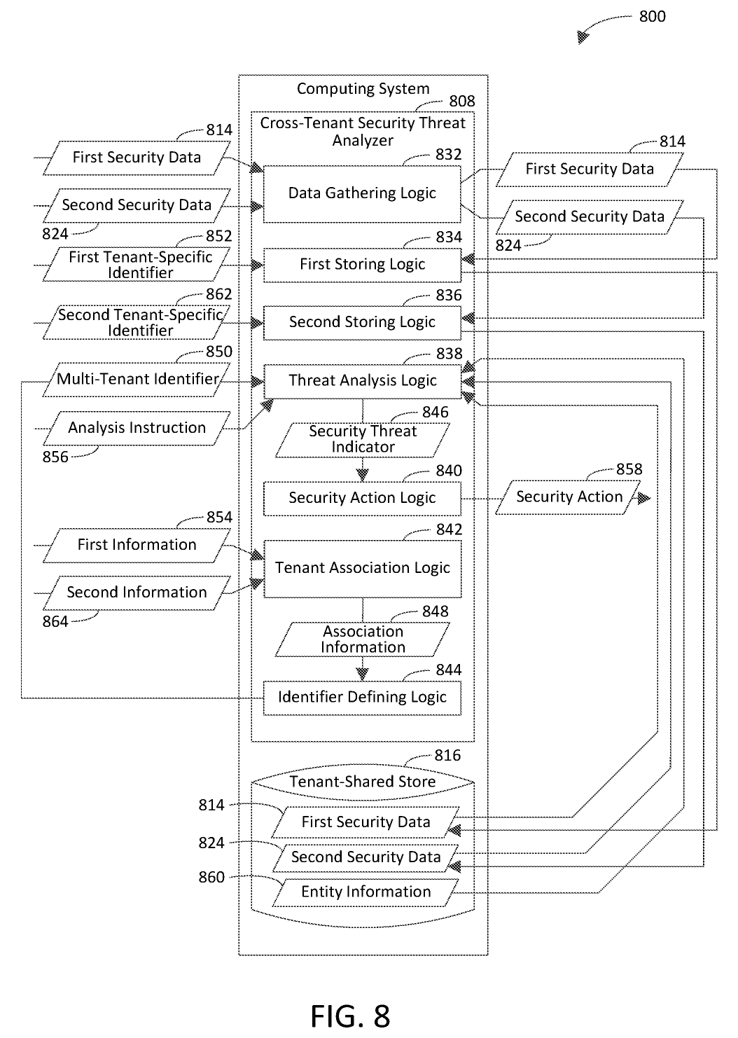

FIG. 8 is a block diagram of an example computing system in accordance with an embodiment.

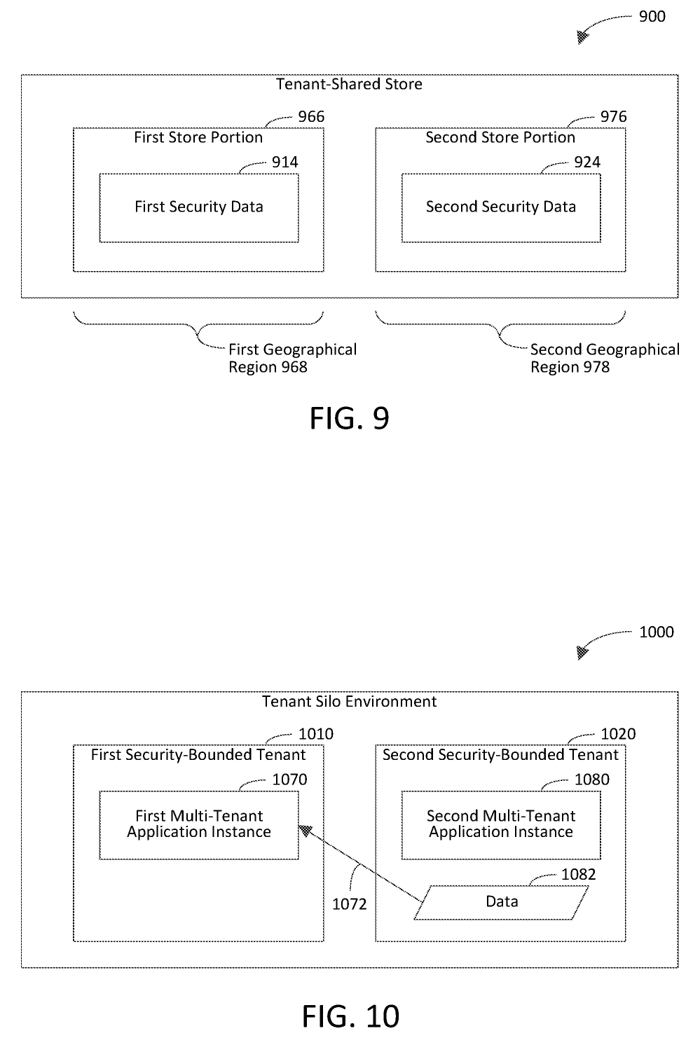

FIG. 9 is a block diagram of an example implementation of a tenant-shared store shown in FIG. 1 in accordance with an embodiment.

FIG. 10 is a block diagram of an example tenant silo environment in accordance with an embodiment.

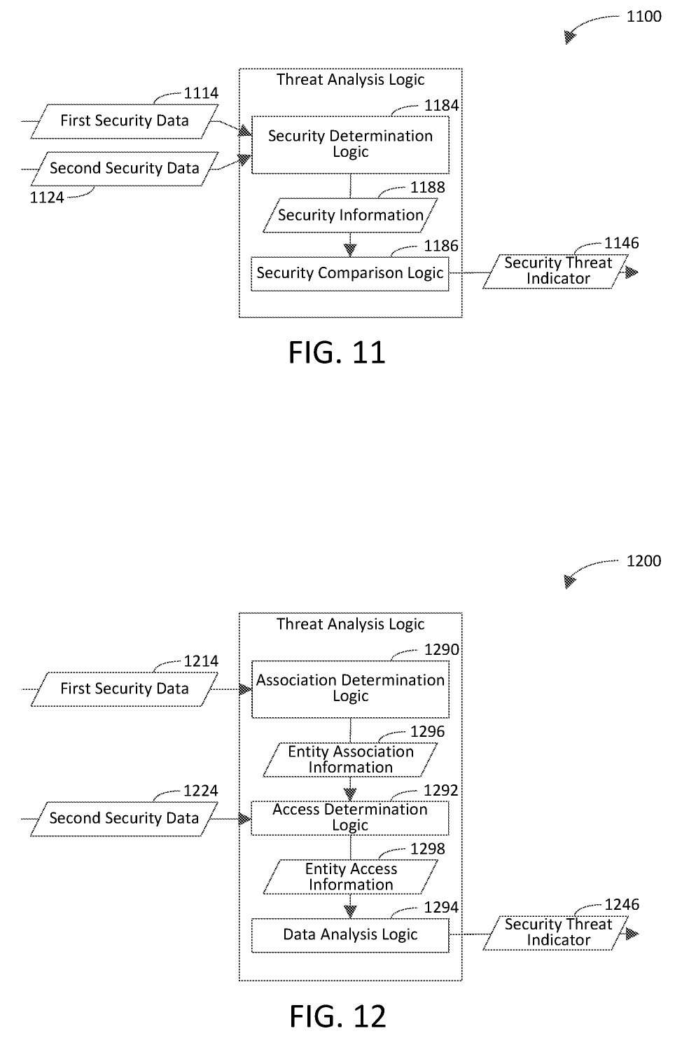

FIGS. 11-12 are block diagrams of example implementations of threat analysis logic shown in FIG. 8 in accordance with embodiments.

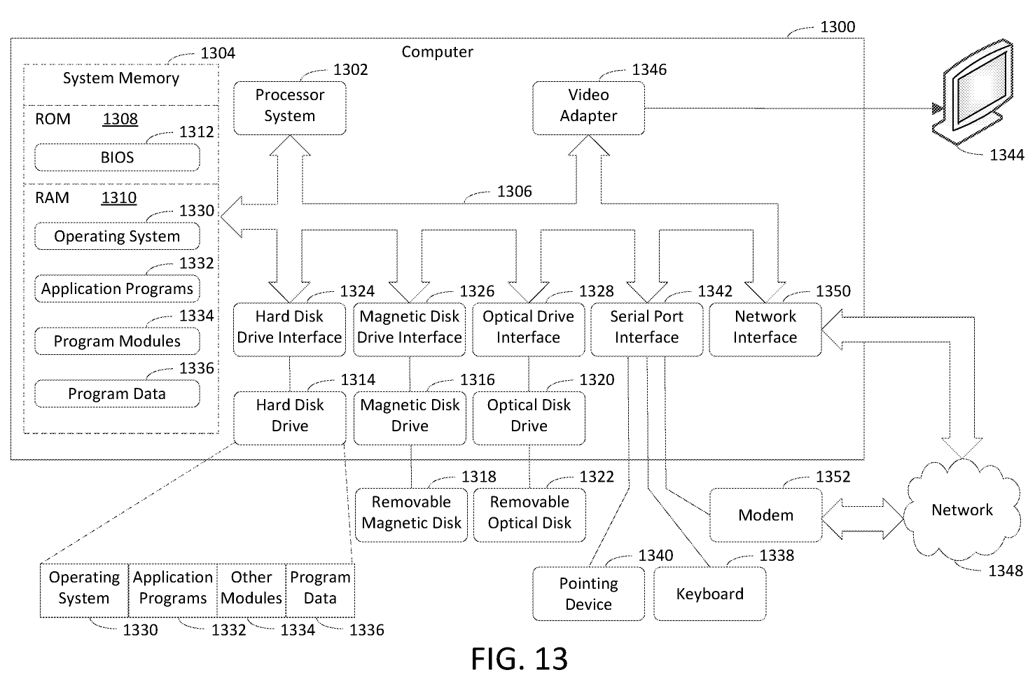

FIG. 13 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

I. Example Embodiments

A security threat may be indicated by occurrence of a security event. A security event is an event that indicates performance of a potentially malicious activity. Examples of a potentially malicious activity include but are not limited to a failed login attempt (i.e. a failure to login to a system), suspicious network activity (e.g., an uncommon pattern of data transfer or an attempt to access sensitive files), an installation of software, and receipt of a phishing email. One example of a security event is receipt of a security alert. A security alert is an alert indicating that a resource is potentially a target of a cyberattack. The security alert may be triggered by a misconfiguration of the resource or a system via which the resource is accessible or by an unexpected, highly impactful, or rare activity being performed with regard to the resource or the system. For instance, a threat actor may exploit a vulnerability of the resource or the system to perpetuate the cyberattack. A threat actor is an entity (e.g., a person, a group of people, or a system (e.g., an autonomous agent)) that intentionally causes (or tries to cause or is configured to cause) harm to a system (e.g., a tenant or a resource therein).

A resource is a component that is capable of being used to perform a task, to execute a process, or to store data. For instance, the resource may be configured to perform the task, to execute the process, or to store the data. Example types of a resource include but are not limited to a hardware resource, a software resource, and a network resource. A hardware resource is a physical resource. Examples of a hardware resource include but are not limited to a computing system (e.g., server), a storage device (e.g., solid-state drive (SSD) or a network-attached storage (NAS)), network equipment (e.g., a router, a switch, or a firewall), and a data center. Examples of a computing system include but are not limited to a desktop computer, a laptop computer, a tablet computer, a wearable computer (e.g., a smart watch or a head-mounted computer), a personal digital assistant, a cellular telephone, and an Internet of things (IoT) device. A software resource is software that is configured to utilize hardware to perform a function. Examples of a software resource include but are not limited to an operating system, an enterprise application, a database management system (DBMS), a software subscription, a virtual machine, an identity (e.g., an identity of a user of a resource, a software application, or an enterprise), a secret, a process, a file, and a folder. A network resource is a resource that facilitates (e.g., enables) data transmission and/or communication between other resources. Examples of a network resource include but are not limited to a local area network (LAN), a wide area network (WAN), and an Internet connectivity component (e.g., an Internet service provider (ISP) component or a virtual private network (VPN) component). For instance, an ISP component may provide Internet access, email, web hosting, and domain registration. A VPN component may provide encryption, privacy, remote access, and bypassing of geo-restrictions.

A resource may be a runtime resource. A runtime resource is a resource that is required for a software application to execute. In an aspect, the runtime resource(s) are provided by a runtime environment or a runtime system, which serves as an intermediary between code of the software application and the underlying hardware and operating system associated with the software application. A runtime resource may have any suitable functionality, including but not limited to memory management, input/output management, error handling, debugging, and optimization. Memory management includes allocating and deallocating memory as needed by the software application. Input/output management includes handling data input from input devices (e.g., a keyboard, a keypad, or a microphone) and output to output devices (e.g., a screen, a speaker, or a printer). Error handling includes management of exceptions and errors that occur during execution of the software application. Debugging includes providing tool(s) that enable a user (e.g., a developer) of the software application to find and fix bugs in the software application. Optimization includes increasing performance of the software application (e.g., by optimizing execution of the software application).

A cyberattack is an attempt to cause harm to a system (e.g., one or more tenants in the system). For instance, the harm may be an unauthorized or illegal access to the system. Examples of a cyberattack include but are not limited to a denial of service (DoS) attack, a distributed DoS (DDoS) attack, a man-in-the-middle (MITM) attack, a malware attack, a phishing attack, a ransomware attack, and a cross-site scripting (XSS) attack. A DoS attack is an attack that renders a system unable to respond to a legitimate service request by overwhelming resource(s) of the system. A DDoS attack is similar to a DoS attack but involves multiple (e.g., a vast array) malware-infected hosts that are controlled by a threat actor to cause resource exhaustion. An MITM attack is an attack that enables a threat actor to eavesdrop on data exchanged between multiple entities (e.g., people, networks, or computers). A malware attack is an attack in which malicious software is introduced (e.g., injected) to a system to damage the system and/or to steal information from the system. A phishing attack is an attack in which a deceptive communication (e.g., an electronic mail (a.k.a. email) message) is provided to an entity to trick the entity into revealing sensitive information or into downloading malware. A ransomware attack is an attack that encrypts file(s) and/or system(s) and demands payment (a.k.a. a ransom) for decryption. An XSS attack exploits a vulnerability of a web application to introduce a malicious script into a web page that is viewed by other users.

A cross-tenant security threat is a security threat that satisfies a first criterion and/or a second criterion. The first criterion requires the security threat to be capable of causing or facilitating harm to multiple tenants in a multi-tenant system. A multi-tenant system is a system that includes multiple tenants that belong to a common entity (e.g., a common organization). The second criterion requires information from at least a first tenant in a multi-tenant system to be used in a manner that is capable of causing or facilitating harm to at least a second tenant in the multi-tenant system. The second tenant is different from the first tenant. For example, the information may be from multiple tenants that include the first tenant (e.g., the first tenant and the second tenant) or from the first tenant alone. In another example, the information may be used in a manner that is capable of causing or facilitating harm to multiple tenants that include the second tenant (e.g., the first tenant and the second tenant) or that is capable of causing or facilitating harm to the second tenant alone.

Cross-tenant security threat analysis is an analysis of first security data from a first tenant (e.g., from a resource in the first tenant) and/or second security data from a second tenant (e.g., from a resource in the second tenant) to identify, assess, and/or address (e.g., contain, mitigate, or remediate) a cross-tenant security threat associated with the first tenant and the second tenant. Security data is data that is used to protect, monitor, or manage security of a system and/or a user of the system. Examples of security data include but are not limited to a log file, an access control list, an audit trail, a configuration file, and threat intelligence. A log file is a record of activity in a system. For instance, the activity may be indicated by event(s) associated with the system. An event associated with a system is an occurrence with regard to the system that potentially impacts security of the system. For instance, the occurrence may be a change in a state of the system, a network utilized by the system, or an application that is utilized by the system or that accesses the system. Examples of an occurrence include but are not limited to a login attempt, a file access, network activity, a system change, a security alert, or a user action. An access control list is a list that defines permissions for user(s) and/or system(s) accessing resources. An audit trail is a record of activities (e.g., transactions) in a system. A configuration file is a file that indicates (e.g., specifies or describes) settings and/or policies related to security of a system. Threat intelligence is data about potential and/or known security threats and security vulnerabilities in a system.

A security-bounded tenant (a.k.a. a “root” or an “organization”) is a tenant that is logically separated from other tenant(s) by a security boundary. A security boundary between security-bounded tenants is configured to protect each of the security bounded tenants from unauthorized access by the other security-bounded tenants. For instance, the security boundary may be enforced through hardware and/or software mechanisms (e.g., encryption and authentication) to maintain confidentiality and integrity of identities and resources in the security-bounded tenants.

A tenant-shared store is a store that is shared by multiple tenants (e.g., multiple security-bounded tenants). In an aspect, the tenant-shared store is configured to store first security data from a first tenant, second security data from a second tenant, and so on.

A unified security account is an account (e.g., an account of a security platform) that is associated with multiple tenants. A security platform is a platform that facilitates management and analysis of security data (e.g., for threat, risk, and posture management). In an aspect, the unified security account is associated with a tenant-shared store.

A tenant-specific identifier is an identifier that is configured to identify (e.g., uniquely identify) a specific tenant. In an aspect, a first tenant-specific identifier is configured to identify a first tenant; a second tenant-specific identifier is configured to identify a second tenant, and so on. For instance, the first tenant-specific identifier may be configured to enable access to the first tenant and not to other tenants; the second tenant-specific identifier may be configured to enable access to the second tenant and not to other tenants, and so on.

A multi-tenant identifier is an identifier that is configured to identify a group of tenants such that the multi-tenant identifier is capable of being used to access information from any one or more of the tenants in the group. The multi-tenant identifier is said to provide multi-tenant permission, which enables access to information from any one or more of the tenants in the group. In an aspect, the multi-tenant permission grants access to first information (e.g., first security data) from a first tenant in the group, second information (e.g., second security data) from a second tenant in the group, and so on.

A security action is an action that is performed in response to (e.g., to address) a security threat. For instance, performance of the security action may be triggered by the security threat. In an aspect, the security action is configured to increase security of system (e.g., a resource in or utilized by the system). For instance, the security action may be configured to increase security of one or more tenants in the system. Examples of a security action include but are not limited to isolating a machine, containing (e.g., quarantining) a user, containing an account, containing a file, containing a folder, stopping a virtual machine, and rotating (e.g., changing) a secret (e.g., a password, an application programming interface (API) key, an encryption key, or other credential). A multi-tenant security action is a security action that is performed with regard to multiple tenants (e.g., simultaneously).

It may be desirable to perform cross-tenant security threat analysis with regard to multiple security-bounded tenants using a multi-tenant identifier associated with a unified security account to enable detection of a cross-tenant security threat. By enabling the detection of the cross-tenant security threat, security of one or more of the security-bounded tenants (e.g., a system that includes the security-bounded tenants) may be increased. For instance, using the multi-tenant identifier to perform the cross-tenant security threat analysis may enable (e.g., cause) the cross-tenant security threat to be detected without a need for a security analyst to switch between the security-bounded tenants manually to do so. For example, using the multi-tenant identifier to perform the cross-tenant security threat analysis may enable the cross-tenant security threat to be automatically detected. By using the multi-tenant identifier, all the security-bounded tenants in the system may be discovered. Discovering all the security-bounded tenants in the system may enable information from the security-bounded tenants to be monitored and managed; machine resources that are unnecessarily duplicative across multiple tenants to be identified and addressed; gaps or inconsistencies in security policies, configurations, or controls of the system to be found; and/or cross-tenant correlation and analysis of security events, alerts, and incidents to be performed.

Example embodiments described herein are capable of performing a security action based on (e.g., based at least on) cross-tenant security threat analysis using a multi-tenant identifier. In an example approach, first security data is gathered from a first resource in a first security-bounded tenant, and second security data is gathered from a second resource in a second security-bounded tenant. The first security data is stored in a tenant-shared store associated with a unified security account using a first tenant-specific identifier associated with the first security-bounded tenant. The second security data is stored in the tenant-shared store using a second tenant-specific identifier associated with the second security-bounded tenant. A cross-tenant security threat analysis is performed with regard to the first security-bounded tenant and the second security-bounded tenant by using a multi-tenant identifier associated with the unified security account to obtain multi-tenant permission to access the first security data and the second security data in the tenant-shared store. As a result of the cross-tenant security threat analysis indicating a security threat with regard to the first security-bounded tenant and/or the second security-bounded tenant, execution of an instruction is triggered. The execution of the instruction causes a security action to be performed with regard to the first security-bounded tenant and/or the second security-bounded tenant.

Example techniques described herein have a variety of benefits as compared to conventional techniques for performing a security threat analysis. For instance, the example techniques are capable of increasing security and privacy of a multi-tenant system and its users to a greater extent than the conventional techniques. For instance, the example techniques are capable of identifying a cross-tenant security threat more accurately, precisely, and/or reliably than the conventional techniques (e.g., by storing security data from the tenants in a unified security account and further by performing a cross-tenant security threat analysis with regard to the tenants using a multi-tenant identifier associated with the unified security account), which increases the security and the privacy of the system (e.g., the tenants therein) and the users. By determining that the cross-tenant security threat analysis indicates a security threat with regard to at least one of the tenants, the example techniques are capable of performing a security action with regard to any one or more of the tenants. Accordingly, the example techniques may be more proactive in addressing cross-tenant security threats.

The example techniques may provide fewer false positives and/or fewer false negatives than the conventional techniques. A false positive is an incorrect determination that an occurrence is a security threat (e.g., a cross-tenant security threat). For instance, the false positive may indicate that a benign occurrence is capable of causing or facilitating harm to a system (e.g., one or more tenants therein) and/or a user of the system. A false negative is an incorrect determination that an occurrence is not a security threat (e.g., not a cross-tenant security threat). For example, the false negative may indicate that an occurrence that constitutes a security threat is not capable of causing or facilitating harm to a system (e.g., one or more tenants therein) and/or a user of the system. Reducing the number of false positives and/or false negatives may increase the security of the system (e.g., tenants therein).

The example techniques may reduce an amount of time and/or resources (e.g., processor cycles, memory, network bandwidth) that is consumed to identify a cross-tenant security threat and/or to address the cross-tenant security threat. For instance, by storing security data from multiple tenants in a unified security account and performing a cross-tenant security threat analysis with regard to the tenants using a multi-tenant identifier associated with the unified security account to identify the cross-tenant security threat, the example techniques may reduce the amount of time and/or resources that otherwise would have been consumed to identify the cross-tenant security threat. By identifying the cross-tenant security threat in this manner, the cross-tenant security threat may be addressed more quickly and/or efficiently, thereby reducing the amount of time and/or resources that is consumed to do so. The example techniques may automate identification of a cross-tenant security threat and/or performance of a security action to address (e.g., contain, mitigate, or remediate) the security threat. By reducing the amount of time and/or resources that is consumed by a computing system to identify a cross-tenant security threat and/or to perform a security action to address the security threat, the efficiency of the computing system may be increased.

By reducing the amount of time that is consumed to identify a cross-tenant security threat and/or to perform a security action to address the security threat, the example techniques may increase a user experience and/or efficiency of a security professional who manages security of a multi-tenant system (e.g., tenants therein) and/or an end user who uses one or more of the tenants (e.g., resource(s) therein). The example techniques may reduce a number of tasks that are manually performed by the security professional and/or the end user by automating identification of a cross-tenant security threat and/or performance of a security action to address (e.g., contain, mitigate, or remediate) the security threat. Reducing the number of tasks that are manually performed by the security professional may enable the security professional to focus on other tasks, which may increase the security of the system. The user experience and/or efficiency of the security professional and/or the end user may be increased in other ways, as well. For example, the user experience and/or the efficiency may be increased by increasing the security of the system. In another example, the user experience and/or the efficiency may be increased through a more accurate, precise, and/or reliable identification of a cross-tenant security threat and/or a quicker and/or more efficient performance of a security action to address the security threat.

FIG. 1 is a block diagram of an example cross-tenant security threat analysis system 100 in accordance with an embodiment. Generally speaking, the cross-tenant security threat analysis system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the cross-tenant security threat analysis system 100 performs a security action based on (e.g., based at least on) cross-tenant security threat analysis using a multi-tenant identifier. Detail regarding techniques for performing a security action based on cross-tenant security threat analysis using a multi-tenant identifier is provided in the following discussion.

As shown in FIG. 1, the cross-tenant security threat analysis system 100 includes a plurality of client devices 102A-102M, a network 104, and a plurality of servers 106A-106N. Communication among the client devices 102A-102M and the servers 106A-106N is carried out over the network 104 using well-known network communication protocols. The network 104 may be a wide-area network (e.g., the Internet), a local area network (LAN), another type of network, or a combination thereof.

The client devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. For instance, a computing system may be a computer, a personal digital assistant, etc. The client devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a client device 102 that is owned by or otherwise accessible to the user. In accordance with some example embodiments, the client devices 102A-102M are capable of accessing domains (e.g., Web sites) hosted by the servers 104A-104N, so that the client devices 102A-102M may access information that is available via the domains. Such domain may include Web pages, which may be provided as hypertext markup language (HTML) documents and objects (e.g., files) that are linked therein, for example.

Each of the client devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the client devices 102A-102M may communicate with any one or more of the servers 106A-106N.

The servers 106A-106N are computing systems that are capable of communicating with the client devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the cross-tenant security threat analysis system 100.

One example type of computer program that may be executed by one or more of the servers 106A-106N is a computer security program. A computer security program is a computer program that provides security with regard to information and/or communications associated with a computing system. For instance, the information associated with the computing system may include information stored on the computing system and/or information accessed (e.g., read) by the computing system. The communications associated with the computing system may include communications received by the computing system and/or communications provided (e.g., transmitted) by the computing system. An example of a communication is an electronic message. In an aspect, the computing system includes one or more resources that are included in one or more tenants. Examples of a computer security program include Bitdefender® security program, developed and distributed by Bitdefender IPR Management Ltd.; Norton® security program, developed and distributed by Gen Digital Inc.; Avast® security program, developed and distributed by Avast Software S.R.O.; McAfee® security program, developed and distributed by McAfee, LLC; and Microsoft Defender® security program, developed and distributed by Microsoft Corporation. It will be recognized that the example techniques described herein may be implemented using a computer security program. For instance, a software product (e.g., a subscription service, a non-subscription service, or a combination thereof) may include the computer security program, and the software product may be configured to perform the example techniques, though the scope of the example embodiments is not limited in this respect.

The computer security program may be a cloud native application protection platform (CNAPP). A CNAPP is an all-in-one platform that unifies security and compliance capabilities to prevent, detect, and respond to cloud security threats. A cloud security threat is a security threat that targets a cloud environment. For instance, the cloud security threat may target cloud-based resources (e.g., storage, computing, and/or networking resources that are accessible via the Internet). A CNAPP integrates multiple cloud security solutions, which traditionally have been siloed, into a common (e.g., single) user interface. The cloud security solutions may include cloud security posture management (CSPM), multipipeline development and operations (DevOps) security, a cloud workload protection platform (CWPP), cloud infrastructure entitlement management (CIEM), and cloud service network security (CSNS). CSPM provides a connected, prioritized view of potential vulnerabilities and misconfigurations across multi-cloud and hybrid environments. The CSPM continuously assesses overall security posture of a system and provides automated alerts and recommendations about critical issues that could expose the system to data breaches. The CSPM may include automated compliance management and remediation tools to identify and remedy compliance deficiencies. Multipipeline DevOps security provides a central console that enables management of DevOps security across multiple (e.g., all) pipelines. For instance, the multipipeline DevOps security may be used to reduce cloud misconfigurations and to scan new code to keep vulnerabilities therein from reaching a production environment. The multipipeline DevOps security may include infrastructure-as-code scanning tools that analyze configuration files from the earliest stages of development to confirm that new configuration files are compliant with security policies. A CWPP provides real-time detection and response to threats based on up-to-date information regarding multi-cloud workloads (e.g., virtual machines, containers, Kubernetes® pods and/or clusters, databases, storage accounts, network layers, and app services). The CWPP may enable a quick investigation into threats and reduce the attack surface of a system. CIEM centralizes permissions management across a cloud and hybrid footprint, which inhibits (e.g., prevents) accidental or malicious misuse of permissions. CSNS complements the CWPP by protecting cloud infrastructure in real time. The CSNS may include any of a variety of security tools, including but not limited to distributed denial-of-service protection, web application firewalls, transport layer security examination, and load balancing.

A computer security program may be incorporated into a cloud computing program (a.k.a. a cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider’s backend services (e.g., push notifications, integration with social networks, and cloud storage) running on a cloud infrastructure. SaaS enables a user to use a SaaS provider’s applications running on a cloud infrastructure. PaaS enables a user to develop and run applications using a PaaS provider’s application development environment (e.g., operating system, programming-language execution environment, database) on a cloud infrastructure. IaaS enables a user to use an IaaS provider’s computer infrastructure (e.g., to support an enterprise). For example, IaaS may provide to the user virtualized computing resources that utilize the IaaS provider’s physical computer resources.

Examples of a cloud computing program include but are not limited to a Google Cloud® program developed and distributed by Google Inc.; an Oracle Cloud® program developed and distributed by Oracle Corporation; an Amazon Web Services® program developed and distributed by Amazon.com, Inc.; a Salesforce® program developed and distributed by Salesforce.com, Inc.; an AppSource® program developed and distributed by Microsoft Corporation; an Azure® program developed and distributed by Microsoft Corporation; a GoDaddy® program developed and distributed by GoDaddy.com LLC; and a Rackspace® program developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include a cross-tenant security threat analyzer 108 and a tenant-shared store 116, which is associated with a unified security account, for illustrative purposes. A first security-bounded tenant 110 includes a first resource 112, which may be included in (e.g., distributed across) any one or more of the servers 106A-106N. A second security-bounded tenant 120 includes a second resource 122, which may be included in (e.g., distributed across) any one or more of the servers 106A-106N. The cross-tenant security threat analyzer 108 is configured to perform a security action based on (e.g., based at least on) cross-tenant security threat analysis using a multi-tenant identifier. In an example implementation, the cross-tenant security threat analyzer 108 gathers first security data 114 from the first resource 112 in the first security-bounded tenant 110 and second security data 124 from the second resource 122 in the second security-bounded tenant 120. The cross-tenant security threat analyzer 108 stores the first security data 114 in the tenant-shared store 116 using a first tenant-specific identifier associated with the first security-bounded tenant 110. The cross-tenant security threat analyzer 108 stores the second security data 124 in the tenant-shared store 116 using a second tenant-specific identifier associated with the second security-bounded tenant 120. The cross-tenant security threat analyzer 108 performs a cross-tenant security threat analysis with regard to the first security-bounded tenant 110 and the second security-bounded tenant 120 by using a multi-tenant identifier associated with the unified security account to obtain multi-tenant permission to access the first security data 114 and the second security data 124 in the tenant-shared store 116. As a result of the cross-tenant security threat analysis indicating a security threat with regard to the first security-bounded tenant 110 and/or the second security-bounded tenant 120, the cross-tenant security threat analyzer 108 triggers execution of an instruction, which causes a security action to be performed with regard to the first security-bounded tenant 110 and/or the second security-bounded tenant 120.

The cross-tenant security threat analyzer 108 may be implemented in various ways to perform a security action based on cross-tenant security threat analysis using a multi-tenant identifier, including being implemented in hardware, software, firmware, or any combination thereof. For example, the cross-tenant security threat analyzer 108 may be implemented as computer program code configured to be executed in one or more processors. In another example, at least a portion of the cross-tenant security threat analyzer 108 may be implemented as hardware logic/electrical circuitry. For instance, at least a portion of the cross-tenant security threat analyzer 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the cross-tenant security threat analyzer 108 may be (or may be included in) a computer security program and/or a cloud computing program, though the scope of the example embodiments is not limited in this respect.

The cross-tenant security threat analyzer 108 and the tenant-shared store 116 are shown to be incorporated in the first server(s) 106A for illustrative purposes and are not intended to be limiting. It will be recognized that the cross-tenant security threat analyzer 108 (or any portion(s) thereof) and/or the tenant-shared store 116 (or any portion(s) thereof) may be incorporated in any one or more of the servers 106A-106N, any one or more of the client devices 102A-102M, or any combination thereof. For example, client-side aspects of the cross-tenant security threat analyzer 108 may be incorporated in one or more of the client devices 102A-102M, and server-side aspects of cross-tenant security threat analyzer 108 may be incorporated in one or more of the servers 106A-106N.

FIGS. 2-4 depict flowcharts 200, 300, and 400 of example methods for performing a security action based on cross-tenant security threat analysis using a multi-tenant identifier in accordance with embodiments. Flowcharts 200, 300, and 400 may be performed by the first server(s) 106A shown in FIG. 1, for example. For illustrative purposes, flowcharts 200, 300, and 400 are described with respect to a computing system 800 shown in FIG. 8, which is an example implementation of the first server(s) 106A. As shown in FIG. 8, the computing system 800 includes a cross-tenant security threat analyzer 808 and a tenant-shared store 816. The cross-tenant security threat analyzer 808 includes data gathering logic 832, first storing logic 834, second storing logic 836, threat analysis logic 838, security action logic 840, tenant association logic 842, and identifier defining logic 844. The tenant-shared store 816 may be any suitable type of store. One type of store is a database. For instance, the tenant-shared store 816 may be a relational database, an entity-relationship database, an object database, an object relational database, an extensible markup language (XML) database, etc. The tenant-shared store 816 is shown to store first security data 814, second security data 824, and entity information 860 for non-limiting, illustrative purposes. Further structural and operational embodiments will be apparent to persons skilled in the relevant art(s) based on the discussion regarding flowcharts 200, 300, and 400.

As shown in FIG. 2, the method of flowchart 200 begins at step 202. In step 202, first security data is gathered from a first resource in a first security-bounded tenant, and second security data is gathered from a second resource in a second security-bounded tenant. In an aspect, each of the first security-bounded tenant and the second security-bounded tenant is associated with one or more on-premises clouds, one or more remote clouds, and/or one or more hybrid clouds. In accordance with this aspect, the first resource is accessed via on-premises cloud(s), remote cloud(s), and/or hybrid cloud(s) associated with the first security-bounded tenant. In further accordance with this aspect, the second resource is accessed via on-premises cloud(s), remote cloud(s), and/or hybrid cloud(s) associated with the second security-bounded tenant. In an example implementation, the data gathering logic 832 gathers the first security data 814 from a first resource in a first security-bounded tenant (e.g., the first resource 112 in the first security-bounded tenant 110 shown in FIG. 1) and the second security data 824 from a second resource in a second security-bounded tenant (e.g., the second resource 122 in the second security-bounded tenant 120 shown in FIG. 1).

In an example log embodiment, the first security data includes one or more logs associated with the first resource, and the second security data includes one or more logs associated with the second resource. A log indicates (e.g., specifies, identifies, or describes) events that occur with regard to one or more entities. For example, the log may be generated based on an operation from an application or a user. In accordance with this example, the application may be a process that is incorporated into a system (i.e., a built-in system process) or a custom application that is generated by a user of the system. Examples of an entity include but are not limited to a user, an application, a computing system, and an Internet Protocol (IP) address. In an aspect, the log pertains to a particular period of time. Examples of a log include but are not limited to a system log, an application log, a security log, a network log, an audit log, an event log, a transaction log, a performance log, a firewall log, and an intrusion detection system (IDS) log. A system log is a log that indicates (e.g., identifies or memorializes) events related to an operating system (e.g., start up events, shutdown event, system errors, and/or hardware changes). An application log is a log that indicates events that are specific to one or more applications (e.g., software errors, user interactions, and/or application-specific messages). A security log is a log that indicates security-related events (e.g., login attempts, access control changes, and/or unauthorized access attempts). A network log is a log that indicates network activity (e.g., data transfer, connection attempts, and/or network errors). An audit log is a log that indicates system and user activity for purposes of accountability and compliance with policies. An event log is a log that indicates events in categories that are deemed to be significant (e.g., system warnings, errors, and/or informational messages). A transaction log is a log that indicates transactions performed by application(s). A performance log is a log that indicates performance metrics (e.g., central processing unit (CPU) usage, memory usage, and/or response times). A firewall log indicates traffic that passes through a firewall, including allowed and blocked connections. An IDS log indicates potential security incidents that are detected by an IDS.

At step 204, the first security data is stored in a tenant-shared store associated with a unified security account using a first tenant-specific identifier associated with the first security-bounded tenant. For instance, the first security data may be stored in the tenant-shared store as a result of gathering the first security data from the first resource. In an example implementation, the first storing logic 834 storing the first security data 814 in the tenant-shared store 816, which is associated with the unified security account, using a first tenant-specific identifier 852, which is associated with the first security-bounded tenant.

At step 206, the second security data is stored in the tenant-shared store using a second tenant-specific identifier associated with the second security-bounded tenant. For instance, the second security data may be stored in the tenant-shared store as a result of gathering the second security data from the second resource. In an example implementation, the second storing logic 836 stores the second security data 824 in the tenant-shared store 816 using a second tenant-specific identifier 862, which is associated with the second security-bounded tenant.

In an aspect of the log embodiment discussed above with regard to step 202, step 204 includes representing (e.g., storing) the first logs associated with the first resource in tables, graphs, or embeddings corresponding to respective types of logs, and step 206 includes representing the second logs associated with the second resource in the tables, the graphs, or the embeddings. For instance, a first table, graph, or embedding may represent a first type of logs; a second table, graph, or embedding may represent a second type of logs, and so on. For example, system logs from the first logs and the second logs may be represented in a system log table, a system log graph, or a system log embedding. In another example, application logs from the first logs and the second logs may be represented in an application log table, an application log graph, or an application log embedding. In yet another example, security logs from the first logs and the second logs may be represented in a security log table, a security log graph, or a security log embedding. A table is a representation of data (e.g., a log or a portion thereof) that is organized in a table format, which includes rows and columns. A graph is a data structure that represents data (e.g., log or a portion thereof) using a finite set of vertices (a.k.a. nodes or points) and a edges (e.g., links or lines) between respective pairs of the vertices. An embedding is a numerical representation of data (e.g., a log or a portion thereof). For instance, the embedding may be generated by converting the data (e.g., text) into a vector (e.g., an array of numbers). In an aspect, the embedding represents the meaning and the context of the data. Embeddings of the logs may serve as generic representations of the logs without requiring explicit feature engineering.

In accordance with this aspect of the log embodiment, each table, graph, or embedding that represents a type of logs may have a set of data attributes that are usable to identify (e.g., select) one or more particular items (e.g., row(s) of the table, vertex(es) in the graph, or attribute(s) of the embedding) for the purpose of performing the cross-tenant security threat analysis. Examples of a data attribute include but are not limited to a tenant attribute, a location attribute, and a sensitivity attribute. A tenant attribute indicates a tenant from which data (e.g., a log) is gathered. A location attribute indicates a geographical location of a resource from which data is gathered. A sensitivity attribute indicates a sensitivity of data. A sensitivity of data may be based on any of a variety of factors, including but not limited to a value (e.g., financial value) of the data, a confidentiality of the data, and a potential impact if the data were to be disclosed, altered, or lost. For instance, the sensitivity of the data may indicate an amount of protection to be provided to the data. In a tenant attribute example of this aspect, a tenant attribute of each row of the table (e.g., represented in a designated column of the table), each vertex of the graph, or each attribute of the embedding that corresponds to a first log from the first resource is set to indicate the first security-bounded tenant. In accordance with the tenant attribute example, the tenant attribute of each row of the table, each vertex of the graph, or each attribute of the embedding that corresponds to a second log from the second resource is set to indicate the second security-bounded tenant.

At step 208, a cross-tenant security threat analysis is performed (e.g., automatically performed) with regard to the first security-bounded tenant and the second security-bounded tenant using a multi-tenant identifier associated with the unified security account. The cross-tenant security threat analysis is performed by analyzing the first security data and/or the second security data in the tenant-shared store In an aspect, the cross-tenant security threat analysis is performed as a result of the multi-tenant identifier providing (e.g., granting or establishing) multi-tenant permission to access the first security-bound tenant and the second security-bound tenant.

In an example implementation, the threat analysis logic 838 performs the cross-tenant security threat analysis with regard to the first security-bounded tenant and the second security-bounded tenant using a multi-tenant identifier 850 associated with the unified security account. The threat analysis logic 838 performs the cross-tenant security threat analysis by analyzing the first security data 814 and/or the second security data 824 in the tenant-shared store 816. In an aspect, the threat analysis logic 838 retrieves the first security data 814 and/or the second security data 824 from the tenant-shared store 816 for analysis. In another aspect, the threat analysis logic 838 performs the cross-tenant security threat analysis as a result of the multi-tenant identifier 850 providing multi-tenant permission to access the first security-bound tenant (e.g., the first security data 814 gathered from the first resource therein) and the second security-bound tenant (e.g., the second security data 824 gathered from the second resource therein). In an example of this aspect, the threat analysis logic 838 performs the cross-tenant security threat analysis further as a result of receiving an analysis instruction 856. In accordance with this example, the analysis instruction 856 instructs the threat analysis logic 838 to perform the cross-tenant security threat analysis.

In accordance with this implementation, the threat analysis logic 838 generates a security threat indicator 846 to indicate (e.g., specify) whether the cross-tenant security threat analysis indicates (e.g., results in identification of) a security threat with regard to the first security-bounded tenant and/or the second security-bounded tenant.

In a first indicator value example, the threat analysis logic 838 may be configured to set the security threat indicator 846 to have a first value (e.g., a first binary value, such as “1”) as a result of the cross-tenant security threat analysis resulting in identification of a security threat with regard to the first security-bounded tenant and/or the second security-bounded tenant. In accordance with this example, the threat analysis logic 838 may be configured to set the security threat indicator 846 to have a second value (e.g., a second binary value, such as “0”) as a result of the cross-tenant security threat analysis not resulting in identification of a security threat with regard to the first security-bounded tenant and/or the second security-bounded tenant. In further accordance with this example, the first value is different form the second value.

In a second indicator value example, the threat analysis logic 838 may be configured to set the security threat indicator 846 to have a first value as a result of the cross-tenant security threat analysis resulting in identification of a security threat with regard to the first security-bounded tenant (e.g., and not with regard to the second security-bounded tenant). In accordance with this example, the threat analysis logic 838 may be configured to set the security threat indicator 846 to have a second value as a result of the cross-tenant security threat analysis resulting in identification of a security threat with regard to the second security-bounded tenant (e.g., and not with regard to the first security-bounded tenant). In further accordance with this example, the threat analysis logic 838 may be configured to set the security threat indicator 846 to have a third value as a result of the cross-tenant security threat analysis resulting in identification of a security threat with regard to the first security-bounded tenant and the second security-bounded tenant. In further accordance with this example, the threat analysis logic 838 may be configured to set the security threat indicator 846 to have a fourth value as a result of the cross-tenant security threat analysis not resulting in identification of a security threat with regard to the first security-bounded tenant and not resulting in identification of a security threat with regard to the second security-bounded tenant. In further accordance with this example, the first value, the second value, the third value, and the fourth value are different.

In accordance with the tenant attribute example of the aspect of the log embodiment discussed above with regard to step 206, the cross-tenant security threat analysis is performed with regard to the first security-bounded tenant and the second security-bounded tenant at step 208 by comparing the multi-tenant identifier to the tenant attributes of the tables, graphs, or embeddings to identify the rows of the tables, vertices in the graphs, or attributes of the embeddings that are to be analyzed in the cross-tenant security threat analysis. For example, because the multi-tenant identifier provides multi-tenant permission to access the first security-bound tenant and the second security-bound tenant, each row of the tables, vertex in the graphs, or attribute of the embeddings that has a tenant attribute indicating the first security-bounded tenant or the second security-bounded tenant is analyzed in the cross-tenant security threat analysis. For instance, the other rows of the tables, vertices in the graphs, or attributes of the embeddings may not be analyzed as a result of those rows, vertices, or attributes not having a tenant attribute indicating the first security-bounded tenant or the second security-bounded tenant.

In an example embodiment, performing the cross-tenant security threat analysis at step 208 includes identifying a security threat with regard to the first security-bounded tenant. In accordance with this embodiment, performing the cross-tenant security threat analysis at step 208 further includes analyzing (e.g., automatically analyzing) the second security data as a result of identifying the security threat with regard to the first security-bounded tenant. In an aspect, identifying the security threat with regard to the first security-bounded tenant triggers analysis of the second security data.

At step 210, a determination is made whether the cross-tenant security threat analysis indicates a security threat with regard to the first security-bounded tenant and/or the second security-bounded tenant. In an example implementation, the security action logic 840 determines whether the cross-tenant security threat analysis indicates a security threat with regard to the first security-bounded tenant and/or the second security-bounded tenant based on the security threat indicator 846.

In a first security threat example, the security threat involves a compromised identity (e.g., account) of an external user (e.g., a guest, a partner, or a contractor) being used to access or attempt to access the first security-bounded tenant and/or the second security-bounded tenant (e.g., the first resource in the first security-bounded tenant and/or the second resource in the second security-bounded tenant). For instance, a threat actor may use the compromised identity to access shared system(s) or data in the first security-bounded tenant and/or the second security-bounded tenant.

In a second security threat example, the security threat involves a relatively permissive trust setting of the first security-bounded tenant and/or the second security-bounded tenant enabling unintended access to the first security-bounded tenant and/or the second security-bounded tenant. For instance, a trust relationship may be established between the first security-bounded tenant and the second security-bounded tenant, a user of the first security-bounded tenant is capable of gaining access to the second security-bounded tenant using the relatively permissive trust setting (e.g., without having to go through a process of becoming a guest user or a business-to-business user, which may be cumbersome).

In a third security threat example, the security threat involves trusting a compromised external tenant. An external tenant is a tenant that is configured to allow external users. By using trusted multi-factor authentication (MFA) or device compliance signals, an external user of the external tenant may bypass established security controls. For instance, the external user may appear as a legitimate user of the external tenant and gain access to the first security-bounded tenant and/or the second security-bounded tenant.

In a fourth security threat example, the security threat involves unauthorized data exfiltration. For instance, an external user with legitimate access to confidential information may intentionally or unintentionally exfiltrate sensitive data from the first security-bounded tenant and/or the second security-bounded tenant. In an aspect, the external user has legitimate access to the first security-bounded tenant and shares sensitive data from the first security-bounded tenant with the second security-bounded tenant. In another aspect, the external user has legitimate access to the second security-bounded tenant and shares sensitive data from the second security-bounded tenant with the first security-bounded tenant.

In a fifth security threat example, the security threat involves an insider threat from an external user. In accordance with this example, the external user has access to the first security-bounded tenant and/or the second security-bounded tenant and uses the access for malicious purposes (e.g., to initiate a cyberattack against the first security-bounded tenant and/or the second security-bounded tenant). For instance, the external user may sabotage a system that includes the first security-bounded tenant and/or the second security-bounded tenant, leak sensitive information from the first security-bounded tenant and/or the second security-bounded tenant, and so on.

In a sixth security threat example, the security threat involves a phishing or social engineering attack. For instance, an external user may be targeted by the attack to gain access to the first security-bounded tenant and/or the second security-bounded tenant.

In a seventh security threat example, the security threat involves a compromise of a muti-tenant application. A multi-tenant application is an application that includes multiple instances configured to execute in respective tenants. For instance, a first instance of the multi-tenant application is configured to execute in the first security-bounded tenant; a second instance of the multi-tenant application is configured to execute in the second security-bounded tenant, and so on. A threat actor may use privileges (e.g., administrator privileges) in the first security-bounded tenant to access the second security-bounded tenant, or vice versa.

In an eighth security threat example, the security threat involves a compromised application programming interface (API) that is exposed across the first and second security-bounded tenants. For instance, the API may be used for malicious purposes if an application (e.g., from an external user) is granted more permissions that are necessary to perform desired tasks with regard to the first security-bounded tenant and/or the second security-bounded tenant.

In a ninth security threat example, the security threat involves a lack of visibility into activities of an external user of the first security-bounded tenant and/or the second security-bounded tenant. For instance, the lack of visibility may result from logs associated with the external user not being captured.

In a tenth security threat example, the security threat involves inconsistent security policies across the first and second security-bounded tenants being used for malicious purposes. In an aspect, a threat actor takes advantage of a gap in the policies of the first security-bounded tenant to initiate a cyberattack against the second security-bounded tenant, or vice versa. For instance, the threat actor may utilize a relatively weak MFA policy of the first security-bounded tenant (as compared to the MFA policy of the second security-bounded tenant) to leverage trust policies of the first security-bounded tenant to access the first resource therein and/or to leverage trust policies of the second security-bounded tenant to access the second resource therein.

In an eleventh security threat example, the security threat involves a compromise of a non-primary (e.g., shadow) tenant (e.g., using a multi-tenant application). For instance, a user in an organization may use an unauthorized cross-tenant application or tool to perform a malicious activity with regard to the non-primary tenant (e.g., leaking data from the non-primary tenant). The non-primary tenant may be the first security-bounded tenant or the second security-bounded tenant. The user may share sensitive files with an unmanaged external tenant using a personal account or an unauthorized application.

In a twelfth security threat example, the security threat involves a tenant takeover attack. A tenant takeover attack is an attack in which control over a tenant (e.g., the first security-bounded tenant or the second security-bounded tenant) is acquired to gain access to resource(s) in the tenant. For instance, the attack may enable a threat actor to gain access to an application that has access to secure data in the tenant. For instance, the threat actor may initiate the attack using credential(s) of an administrator who manages the first security-bounded tenant and/or the second security-bounded tenant. The threat actor may obtain the credential(s) through a leak or as a result of the credential(s) being weak enough to guess. For instance, the threat actor may compromise an administrator account in a trusted external tenant and escalate privileges to gain access to the first resource in the first security-bounded tenant and/or the second resource in the second security-bounded tenant. The threat actor may compromise a global administrator account in the external tenant and use elevated access privileges granted by the global administrator account to access application(s) or data in the first security-bounded tenant and/or the second security-bounded tenant via cross-tenant access.

In an aspect of the first security value example described above with regard to step 208, the security action logic 840 may determine that the cross-tenant security threat analysis indicates a security threat with regard to the first security-bounded tenant and/or the second security-bounded tenant based on the security threat indicator 846 having the first value (e.g., “1”). In another aspect of the first security value example, the security action logic 840 may determine that the cross-tenant security threat analysis does not indicate a security threat with regard to the first security-bounded tenant and/or the second security-bounded tenant based on the security threat indicator 846 having the second value (e.g., “0”).

In an aspect of the second security value example described above with regard to step 208, the security action logic 840 may determine that the cross-tenant security threat analysis indicates a security threat with regard to the first security-bounded tenant (e.g., and not the second security-bounded tenant) based on the security threat indicator 846 having the first value. In another aspect of the second security value example, the security action logic 840 may determine that the cross-tenant security threat analysis indicates a security threat with regard to the second security-bounded tenant (e.g., and not the first security-bounded tenant) based on the security threat indicator 846 having the second value. In yet another aspect of the second security value example, the security action logic 840 may determine that the cross-tenant security threat analysis indicates a security threat with regard to the first security-bounded tenant and the second security-bounded tenant based on the security threat indicator 846 having the third value. In still another aspect of the second security value example, the security action logic 840 may determine that the cross-tenant security threat analysis does not indicate a security threat with regard to the first security-bounded tenant and does not indicate a security threat with regard to the second security-bounded tenant based on the security threat indicator 846 having the fourth value.

If the cross-tenant security threat analysis indicates a security threat with regard to the first security-bounded tenant and/or the second security-bounded tenant, flow continues to step 212. Otherwise, flow continues to step 214.

In an example embodiment, the cross-tenant security analysis (e.g., analysis of the first security data and/or the second security data) indicates that a specified amount of data is exfiltrated from a particular tenant (e.g., the first security-bounded tenant or the second security-bounded tenant) or a combination of tenants (e.g., a combination of the first security-bounded tenant and the second security-bounded tenant). In accordance with this embodiment, step 210 includes determining that the cross-tenant security threat analysis indicates the security threat with regard to the first security-bounded tenant and/or the second security-bounded tenant as a result of the specified amount of the data that is exfiltrated being greater than or equal to a threshold amount.

In another example embodiment, the cross-tenant security analysis (e.g., analysis of the first security data and/or the second security data) indicates that data from a particular tenant (e.g., the first security-bounded tenant or the second security-bounded tenant) or a combination of tenants (e.g., a combination of the first security-bounded tenant and the second security-bounded tenant) is shared with an entity. In accordance with this embodiment, step 210 includes determining that the cross-tenant security threat analysis indicates the security threat with regard to the first security-bounded tenant and/or the second security-bounded tenant as a result of the data being shared with the entity in a manner that violates a policy. The policy may be violated in any of a variety of ways, including but not limited to the entity not being authorized to access the data (e.g., the entity not being an authorized user of the first security-bounded tenant and/or the second security-bounded tenant), the data being shared with the entity at a time that is not within an authorized time range, and the entity is not at an authorized location at a time instance at which the data is shared (e.g., the entity attempting to access the data from a device that is not located at the authorized location).

In yet another example embodiment, the cross-tenant security analysis indicates that an operation is performed with regard to the first resource (e.g., as indicated by the first security data) and/or the second resource (e.g., as indicated by the second security data). In accordance with this embodiment, step 210 includes determining that the cross-tenant security threat analysis indicates the security threat with regard to the first security-bounded tenant and/or the second security-bounded tenant as a result of the cross-tenant security analysis indicating that an extent of harm that the operation is capable of causing to the first security-bounded tenant and/or the second security-bounded tenant is greater than or equal to an extent threshold. The extent of harm may be based on any of a variety of factors, including but not limited to a blast radius associated with the operation (e.g., a number of users and/or resources that are capable of being harmed by the operation) and a severity of the harm.

At step 212, execution of an instruction is triggered (e.g., automatically triggered), which causes a security action to be performed with regard to the first security-bounded tenant and/or the second security-bounded tenant. In an example implementation, the security action logic 840 triggers the execution of the instruction. By triggering the execution of the instruction, the security action logic 840 causes a security action 858 to be performed with regard to the first security-bounded tenant and/or the second security-bounded tenant.

In an example embodiment, triggering the execution of the instruction at step 212 includes, as a result of the cross-tenant security threat analysis indicating a multi-tenant security threat with regard to the first security-bounded tenant and the second security-bounded tenant, triggering (e.g., automatically triggering) the execution of the instruction. In accordance with this embodiment, triggering the execution of the instruction causes a multi-tenant security action to be performed with regard to the first security-bounded tenant and the second security-bounded tenant.

At step 214, execution of the instruction is not triggered. Accordingly, the security action is not performed with regard to the first security-bounded tenant and/or the second security-bounded tenant. In an example implementation, the security action logic 840 does not trigger the execution of the instruction and therefore does not cause the security action 858 to be performed with regard to the first security-bounded tenant and/or the second security-bounded tenant.

In an example data corpus embodiment, gathering the first security data and the second security data at step 202 includes gathering a first corpus of security data, which includes the first security data, from the first resource in the first security-bounded tenant and a second corpus of security data, which includes the second security data, from the second resource in the second security-bounded tenant. In accordance with this embodiment, storing the first security data at step 204 includes storing the first corpus of security data in the tenant-shared store using the first tenant-specific identifier. In further accordance with this embodiment, storing the second security data at step 206 includes storing the second corpus of security data in the tenant-shared store using the second tenant-specific identifier. In further accordance with this embodiment, performing the cross-tenant security threat analysis at step 208 includes providing a search query against the tenant-shared store. The search query specifies a data attribute. In further accordance with this embodiment, performing the cross-tenant security threat analysis at step 208 includes, in response to the search query, receiving the first security data and the second security data, rather than an entirety of the first corpus of security data and an entirety of the second corpus of the security data, as a result of the first security data and the second security data having the data attribute.

In an example geographical region embodiment, storing the first security data in the tenant-shared store at step 204 includes storing the first security data in a first portion of the tenant-shared store. The first portion is located in a first geographical region in which the first security data is generated. In accordance with this embodiment, storing the second security data in the tenant-shared store at step 206 includes storing the second security data in a second portion of the tenant-shared store. The second portion is located in a second geographical region in which the second security data is generated. In an aspect, the first security data is stored in the first portion of the tenant-shared store and the second security data is stored in the second portion of the tenant-shared store to comply with data residency requirements associated with the first security data and the second security data. In an example implementation, the first geographical region is a first country or a first union of countries, and the second geographical region is a second country or a second union of countries. In accordance with this implementation, a first sovereign regulation enforced by a government of the first geographical region requires data (e.g., the first security data) that is generated in the first geographical region to be stored in (e.g., to remain within) the first geographical region. In further accordance with this implementation, a second sovereign regulation enforced by a government of the second geographical region requires data (e.g., the second security data) that is generated in the second geographical region to be stored in (e.g., to remain within) the second geographical region. The second geographical region may be non-overlapping with the first geographical region.

An example implementation of the geographical region embodiment will be described with reference to FIG. 9. FIG. 9 is a block diagram of an example tenant-shared store 900, which is an example implementation of the tenant-shared store 116 shown in FIG. 1, in accordance with an embodiment. In an aspect, the tenant-shared store 900 is an example implementation of a tenant-shared store 816 shown in FIG. 8. As shown in FIG. 9, the tenant-shared store 900 includes a first store portion 966 and a second store portion 976. First security data 914 is stored in the first store portion 966, which is located in a first geographical region 968 in which the first security data 914 is generated. Second security data 924 is stored in the second store portion 976, which is located in a second geographical region 978 in which the second security data 924 is generated.

In an example multi-tenant application embodiment, a first instance of a multi-tenant application executes in the first security-bounded tenant, and a second instance of the multi-tenant application executes in the second security-bounded tenant. In accordance with this embodiment, performing the cross-tenant security threat analysis at step 208 includes determining that the first instance of the multi-tenant application, which executes in the first security-bounded tenant, accesses data that is stored in the second security-bounded tenant. In further accordance with this embodiment, a determination is made at step 210 that the cross-tenant security threat analysis indicates the security threat as a result of determining that the first instance of the multi-tenant application accesses the data that is stored in the second security-bounded tenant. In an aspect of this embodiment, the method of flowchart 200 further includes provisioning the first instance of the multi-tenant application in the first security-bounded tenant and provisioning the second instance of the multi-tenant application in the second security-bounded tenant. For example, the first storing logic 834 may provision the first instance of the multi-tenant application in the first security-bounded tenant. In accordance with this example, the second storing logic 836 may provision the second instance of the multi-tenant application in the second security-bounded tenant.

An example implementation of the multi-tenant application embodiment will be described with reference to FIG. 10. FIG. 10 is a block diagram of an example tenant silo environment 1000 in accordance with an embodiment. As shown in FIG. 10, the tenant silo environment 1000 includes a first security-bounded tenant 1010 and a second tenant-bounded tenant 1020. A first multi-tenant application instance 1070 (i.e., a first instance of a multi-tenant application) executes in the first security-bounded tenant 1010. A second multi-tenant application instance 1080 (i.e., a second instance of the multi-tenant application) executes in the second security-bounded tenant 1020. As indicated by arrow 1072, the first multi-tenant application instance 1070, which executes in the first security-bounded tenant 1010, accesses data 1082 that is stored in the second security-bounded tenant 1020. By recognizing that the first multi-tenant application instance 1070 accesses the data 1082 that is stored in the second security-bounded tenant 1020, the security action logic 840 in FIG. 8 determines that the cross-tenant security threat analysis indicates a security threat.

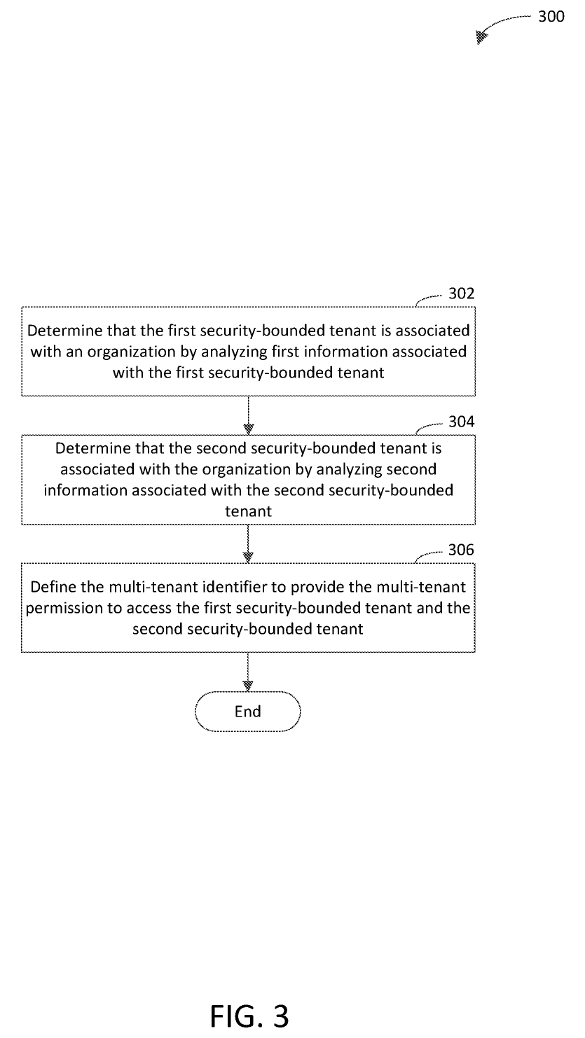

In some example embodiments, one or more steps 202, 204, 206, 208, 210, 212, and/or 214 of flowchart 200 may not be performed. Moreover, steps in addition to or in lieu of steps 202, 204, 206, 208, 210, 212, and/or 214 may be performed. For instance, in an example embodiment, the method of flowchart 200 further includes one or more steps of flowchart 300 shown in FIG. 3. As shown in FIG. 3, the method of flowchart 300 begins at step 302. In step 302, a determination is made that the first security-bounded tenant is associated with an organization by analyzing first information associated with the first security-bounded tenant. In an aspect, the determination is made as a result of the first information indicating the organization. For instance, the first information may indicate the organization by referencing (e.g., mentioning or discussing) or specifying (e.g., identifying) the organization. In accordance with this aspect, the determination may be made as a result of the first information indicating an account of the organization. In another aspect, the first security-bounded tenant is associated with the organization by being attached to an account of the organization or by belonging to the organization. In an example implementation, the tenant association logic 842 determines that the first security-bounded tenant is associated with the organization by analyzing first information 854 associated with the first security-bounded tenant.

At step 304, a determination is made that the second security-bounded tenant is associated with the organization by analyzing second information associated with the second security-bounded tenant. In an aspect, the determination is made as a result of the second information indicating the organization. For instance, the second information may indicate the organization by referencing (e.g., mentioning or discussing) or specifying (e.g., identifying) the organization. In accordance with this aspect, the determination may be made as a result of the second information indicating an account of the organization. In another aspect, the second security-bounded tenant is associated with the organization by being attached to an account of the organization or by belonging to the organization. In an example implementation, the tenant association logic 842 determines that the second security-bounded tenant is associated with the organization by analyzing second information 864 associated with the second security-bounded tenant. The tenant association logic 842 generates association information 848 to indicate that the first security-bounded tenant and the second security-bounded tenant are associated with the organization.

At step 306, the multi-tenant identifier is defined to provide the multi-tenant permission to access the first security-bounded tenant and the second security-bounded tenant. In an aspect, the multi-tenant identifier is defined to provide the multi-tenant permission as a result of determining that the first security-bounded tenant is associated with the organization and further as a result of determining that the second security-bounded tenant is associated with the organization. In an example implementation, the identifier defining logic 844 defines the multi-tenant identifier 850 to provide the multi-tenant permission to access the first security-bounded tenant and the second security-bounded tenant. For instance, the identifier defining logic 844 may define the multi-tenant identifier 850 to provide the multi-tenant permission as a result of the association information 848 indicating that the first security-bounded tenant and the second security-bounded tenant are associated with the organization.

In an aspect of this embodiment, performing the cross-tenant security threat analysis at step 208 includes determining that the first security-bounded tenant is associated with an organization by analyzing the first information at step 302 and determining that the second security-bounded tenant is associated with the organization by analyzing the second information at step 304.

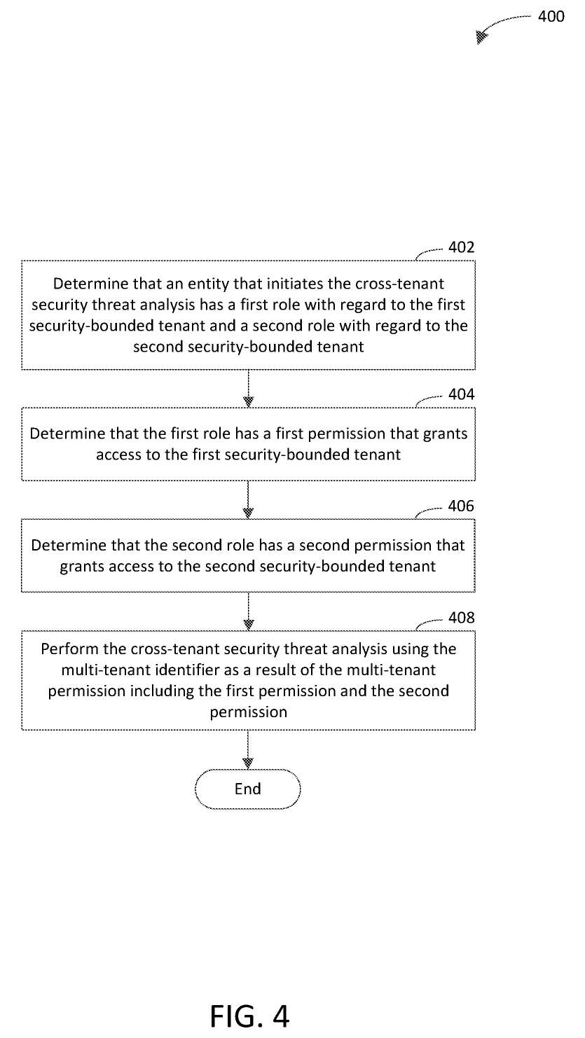

In another example embodiment, the method of flowchart 200 includes one or more steps of flowchart 400 shown in FIG. 4. As shown in FIG. 4, the method of flowchart 400 begins at step 402. In step 402, a determination is made that an entity that initiates the cross-tenant security threat analysis has a first role with regard to the first security-bounded tenant and a second role with regard to the second security-bounded tenant. For instance, the first role and the second role may be assigned from an attribute-based access control (ABAC) policy. The ABAC policy may be an account-level policy (e.g., a policy associated with the unified security account, which is associated with the tenant-shared store). In an aspect, step 402 includes determining that the entity initiates the cross-tenant security threat analysis by issuing a query against the tenant-shared store. For example, the query may be generated using a call to a representational state transfer (REST) application programming interface (API) (referred to as a “REST API call”) or using a software development kit (SDK). In another example, the query may be generated using native support for a query language, such as Kusto Query Language (KQL). For instance, the entity may use the query language to generate the query using a big data analytics platform, such as the Azure® Data Explorer™ platform, even if the entity does not have experience with writing code.

In an example implementation, the threat analysis logic 838 determines that the entity that initiates the cross-tenant security threat analysis has the first role with regard to the first security-bounded tenant and the second role with regard to the second security-bounded tenant. In an aspect, the entity information 860, which is stored in the tenant-shared store 816, includes information about the entity. For example, the entity information 860 may indicate that the entity has the first role with regard to the first security-bounded tenant and the second role with regard to the second security-bounded tenant. In accordance with this example, the threat analysis logic 838 may make the determination at step 402 as a result of the entity information 860 indicating that the entity has the first role with regard to the first security-bounded tenant and the second role with regard to the second security-bounded tenant.

At step 404, a determination is made that the first role has a first permission that grants access to the first security-bounded tenant. In an example implementation, the threat analysis logic 838 determines that the first role has the first permission, which grants access to the first security-bounded tenant. For example, the entity information 860 may indicate that the first role has the first permission and that the first permission grants access to the first security-bounded tenant. In accordance with this example, the threat analysis logic 838 may make the determination at step 404 as a result of the entity information 860 indicating that the first role has the first permission and further indicating that the first permission grants access to the first security-bounded tenant.

At step 406, a determination is made that the second role has a second permission that grants access to the second security-bounded tenant. In an example implementation, the threat analysis logic 838 determines that the second role has the second permission, which grants access to the second security-bounded tenant. For example, the entity information 860 may indicate that the second role has the second permission and that the second permission grants access to the second security-bounded tenant. In accordance with this example, the threat analysis logic 838 may make the determination at step 406 as a result of the entity information 860 indicating that the second role has the second permission and further indicating that the second permission grants access to the second security-bounded tenant.

At step 408, the cross-tenant security threat analysis is performed using the multi-tenant identifier as a result of the multi-tenant permission including the first permission, which grants the entity access to the first security-bounded tenant, and the second permission, which grants the entity access to the second security-bounded tenant. In an aspect, step 408 is included in step 208 shown in FIG. 2. In an example implementation, the threat analysis logic 838 performs the cross-tenant security threat analysis using the multi-tenant identifier 850 as a result of the multi-tenant permission including the first permission and the second permission.

It will be recognized that the computing system 800 may not include one or more of the cross-tenant security threat analyzer 808, the tenant-shared store 816, the data gathering logic 832, the first storing logic 834, the second storing logic 836, the threat analysis logic 838, the security action logic 840, the tenant association logic 842, and/or the identifier defining logic 844. Furthermore, the computing system 800 may include components in addition to or in lieu of the cross-tenant security threat analyzer 808, the tenant-shared store 816, the data gathering logic 832, the first storing logic 834, the second storing logic 836, the threat analysis logic 838, the security action logic 840, the tenant association logic 842, and/or the identifier defining logic 844.

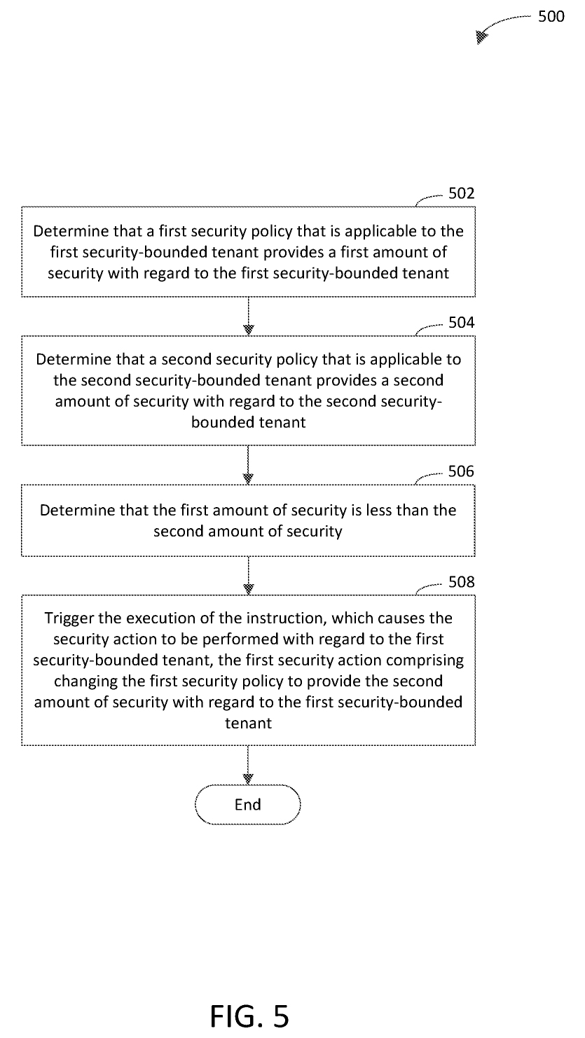

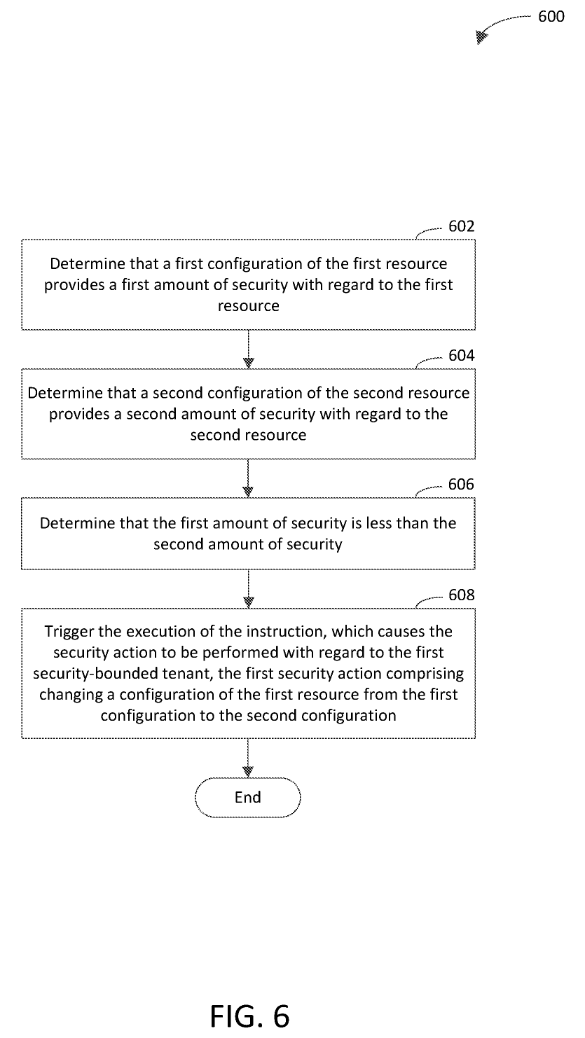

In other example embodiments, the method of flowchart 200 includes one or more steps of flowchart 500 shown in FIG. 5 and/or one or more steps of flowchart 600 shown in FIG. 6. Flowcharts 500 and 600 may be performed by the threat analysis logic 838 shown in FIG. 8, for example. For illustrative purposes, flowcharts 500 and 600 are described with respect to threat analysis logic 1100 shown in FIG. 11, which is an example implementation of the threat analysis logic 838. As shown in FIG. 11, the threat analysis logic 1100 includes security determination logic 1184 and security comparison logic 1186. Further structural and operational embodiments will be apparent to persons skilled in the relevant art(s) based on the discussion regarding flowcharts 500 and 600.

As shown in FIG. 5, the method of flowchart 500 begins at step 502. In step 502, a determination is made that a first security policy that is applicable to the first security-bounded tenant provides a first amount of security with regard to the first security-bounded tenant. In an example implementation, the security determination logic 1184 determines that the first security policy, which is applicable to the first security-bounded tenant, provides the first amount of security with regard to the first security-bounded tenant. In an aspect, the security determination logic 1184 analyzes first security data 1114 to determine that the first security policy provides the first amount of security with regard to the first security-bounded tenant.

At step 504, a determination is made that a second security policy that is applicable to the second security-bounded tenant provides a second amount of security with regard to the second security-bounded tenant. In an example implementation, the security determination logic 1184 determines that the second security policy, which is applicable to the second security-bounded tenant, provides the second amount of security with regard to the second security-bounded tenant. In an aspect, the security determination logic 1184 analyzes second security data 1124 to determine that the second security policy provides the second amount of security with regard to the second security-bounded tenant. The security determination logic 1184 generates security information 1188 to indicate that the first security policy provides the first amount of security with regard to the first security-bounded tenant and to further indicate that the second security policy provides the second amount of security with regard to the second security-bounded tenant.

In an aspect of this embodiment, steps 502 and 504 are included in step 208 shown in FIG. 2.

At step 506, a determination is made that the first amount of security is less than the second amount of security. In an aspect, step 506 is included in step 210 shown in FIG. 2. In an example implementation, the security comparison logic 1186 determines that the first amount of security is less than the second amount of security. In an aspect, the security comparison logic 1186 compares the first amount of security, as indicated by the security information 1188, and the second amount of security, as further indicated by the security information 1188, to determine that the first amount of security is less than the second amount of security.

At step 508, the execution of the instruction is triggered, which causes the security action to be performed with regard to the first security-bounded tenant. The first security action includes changing the first security policy to provide the second amount of security with regard to the first security-bounded tenant. In an aspect, the execution of the instruction is triggered at step 508 as a result of the first amount of security being less than the second amount of security indicating the security threat with regard to the first security-bounded tenant. For instance, the first amount of security being less than the second amount of security may result in (e.g., constitute) the security threat. In an aspect, step 508 is included in step 212 shown in FIG. 2. In an example implementation, the security comparison logic 1186 triggers the execution of the instruction. By triggering the execution of the instruction, the security comparison logic 1186 causes the security action to be performed with regard to the first security-bounded tenant (e.g., as a result of the first amount of security being less than the second amount of security indicating the security threat with regard to the first security-bounded tenant). In an aspect, by triggering the execution of the instruction, the security comparison logic 1186 generates a security threat indicator 1146, which indicates the security threat with regard to the first security-bounded tenant. For instance, the security threat indicator 1146 may instruct the security action logic 840 in FIG. 8 to perform the security action (e.g., security action 858) with regard to the first security-bounded tenant.

As shown in FIG. 6, the method of flowchart 600 begins at step 602. In step 602, a determination is made that a first configuration of the first resource provides a first amount of security with regard to the first resource. In an example implementation, the security determination logic 1184 determines that the first configuration of the first resource provides the first amount of security with regard to the first resource. In an aspect, the security determination logic 1184 analyzes first security data 1114 to determine that the first configuration of the first resource provides the first amount of security with regard to the first resource.

At step 604, a determination is made that a second configuration of the second resource provides a second amount of security with regard to the second resource. In an example implementation, the security determination logic 1184 determines that the second configuration of the second resource provides the second amount of security with regard to the second resource. In an aspect, the security determination logic 1184 analyzes second security data 1124 to determine that the second configuration of the second resource provides the second amount of security with regard to the second resource. The security determination logic 1184 generates security information 1188 to indicate that the first configuration of the first resource provides the first amount of security with regard to the first resource and to further indicate that the second configuration of the second resource provides the second amount of security with regard to the second resource.

In an aspect of this embodiment, steps 602 and 604 are included in step 208 shown in FIG. 2.

At step 606, a determination is made that the first amount of security is less than the second amount of security. In an aspect, step 606 is included in step 210 shown in FIG. 2. In an example implementation, the security comparison logic 1186 determines that the first amount of security is less than the second amount of security. In an aspect, the security comparison logic 1186 compares the first amount of security, as indicated by the security information 1188, and the second amount of security, as further indicated by the security information 1188, to determine that the first amount of security is less than the second amount of security.

At step 608, the execution of the instruction is triggered, which causes the security action to be performed with regard to the first security-bounded tenant. The first security action includes changing a configuration of the first resource from the first configuration to the second configuration. In an aspect, the execution of the instruction is triggered at step 608 as a result of the first amount of security being less than the second amount of security indicating the security threat with regard to the first security-bounded tenant. For instance, the first amount of security being less than the second amount of security may result in (e.g., constitute) the security threat. In an aspect, step 608 is included in step 212 shown in FIG. 2. In an example implementation, the security comparison logic 1186 triggers the execution of the instruction. By triggering the execution of the instruction, the security comparison logic 1186 causes the security action to be performed with regard to the first security-bounded tenant (e.g., as a result of the first amount of security being less than the second amount of security indicating the security threat with regard to the first security-bounded tenant). In an aspect, by triggering the execution of the instruction, the security comparison logic 1186 generates a security threat indicator 1146, which indicates the security threat with regard to the first security-bounded tenant. For instance, the security threat indicator 1146 may instruct the security action logic 840 in FIG. 8 to perform the security action (e.g., security action 858) with regard to the first security-bounded tenant.

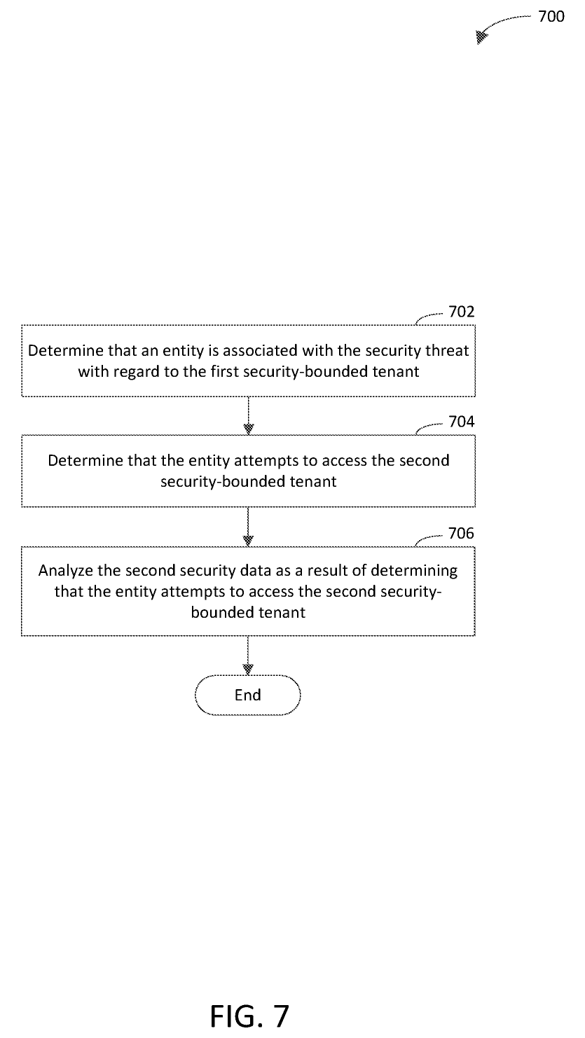

In another example embodiment, the method of flowchart 200 includes one or more steps of flowchart 700 shown in FIG. 7. Flowchart 700 may be performed by the threat analysis logic 838 shown in FIG. 8, for example. For illustrative purposes, flowchart 700 is described with respect to threat analysis logic 1200 shown in FIG. 12, which is an example implementation of the threat analysis logic 838. As shown in FIG. 12, the threat analysis logic 1200 includes association determination logic 1290, access determination logic 1292, and data analysis logic 1294. Further structural and operational embodiments will be apparent to persons skilled in the relevant art(s) based on the discussion regarding flowchart 700.

As shown in FIG. 7, the method of flowchart 700 begins at step 702. In step 702, a determination is made that an entity is associated with (e.g., initiates or causes) the security threat with regard to the first security-bounded tenant. In an example implementation, the association determination logic 1290 determines that the entity is associated with the security threat with regard to the first security-bounded tenant. In an aspect, the association determination logic 1290 analyzes first security data 1214 to determine that the security threat pertains to the first security-bounded tenant and to further determine that the entity is associated with the security threat. The association determination logic 1290 generates the entity association information 1296 to indicate that the entity is associated with the security threat with regard to the first security-bounded tenant. For instance, the entity association information 1296 may indicate that the security threat pertains to the first security-bounded tenant and to further indicate that the entity is associated with the security threat.

At step 704, a determination is made that the entity attempts to access the second security-bounded tenant. For example, the entity may be a malicious insider in an organization that owns the first and second security-bounded tenants. In another example, the entity may be a malicious entity that is external to the organization (e.g., who attempts to access the second security-bounded tenant using a credential of a user in the organization). In yet another example, the entity may attempt to access the second security-bounded tenant as a guest of the second security-bounded tenant. A guest of a tenant is an entity that is granted temporary access to resource(s) of the tenant (e.g., with limited privileges). As a guest, the entity may be allowed to use a guest account that has generic, restricted privileges to access the tenant, rather than a personalized account that has broader privileges tailored to the entity. In an aspect, the determination is made at step 704 in response to determining that the entity is associated with the security threat with regard to the first security-bounded tenant.

In an example implementation, the access determination logic 1292 determines that the entity attempts to access the second security-bounded tenant. In an aspect, the access determination logic 1292 analyzes second security data 1224 to determine that the entity attempts to access the second security-bounded tenant. In another aspect, the access determination logic 1292 makes the determination in response to the entity association information 1296 indicating that the entity is associated with the security threat with regard to the first security. For instance, the entity association information 1296 indicating that the entity is associated with the security threat with regard to the first security may trigger the access determination logic 1292 to analyze the second security data 1224 to determine whether the entity has attempted to access the second security-bounded tenant. The access determination logic 1292 generates entity access information 1298 to indicate that the entity attempts (e.g., has attempted) to access the second security-bounded tenant.

At step 706, the second security data is analyzed as a result of determining that the entity attempts to access the second security-bounded tenant. In an example implementation, the data analysis logic 1294 analyzes second security data 1224 as a result of determining that the entity attempts to access the second security-bounded tenant. In an aspect, the data analysis logic 1294 analyzes second security data 1224 as a result of the entity access information 1298 indicating that the entity attempts to access the second security-bounded tenant. In another aspect, if the data analysis logic 1294 determines that the entity successfully accesses the second security-bounded tenant, the data analytics logic 1294 generates a security threat indicator 1246, which indicates that the entity has successfully accessed the second security-bounded tenant. For instance, the security threat indicator 1246 may indicate that the security threat includes the entity successfully accessing the second security-bounded tenant.

In an aspect of this embodiment, determining that the entity attempts to access the second security-bounded tenant at step 704 includes determining that the entity attempts to access the second security-bounded tenant using a secret that is obtained from (e.g., stored in) the first security-bounded tenant. Examples of a secret include but are not limited to a certificate, a configuration setting, a token, a key, and a credential. Examples of a key include but are not limited to an application programming interface (API) key, a secure shell (SSH) key, an encryption key, and a decryption key. A key may be an asymmetric key (e.g., a private key or a public key) or a symmetric key. Examples of a credential include but are not limited to a username, a password, and a personal identification number (PIN). In accordance with this aspect, the second security data is analyzed at step 706 as a result of determining that the entity attempts to access the second security-bounded tenant using the secret that is obtained from the first security-bounded tenant.

In another aspect of this embodiment, the method of flowchart 700 includes determining that the first security-bounded tenant and the second security-bounded tenant have a common security vulnerability. For instance, the common security vulnerability may include (e.g., be) a vulnerability in a script or a policy that is shared by the first security-bounded tenant and the second security-bounded tenant. In an example implementation, the association determination logic 1290 determines that the first security-bounded tenant and the second security-bounded tenant have the common security vulnerability. In accordance with this aspect, the method of flowchart 700 includes determining that the entity uses the common security vulnerability to initiate the security threat with regard to the first security-bounded tenant. In an example implementation, the association determination logic 1290 determines that the entity uses the common security vulnerability to initiate the security threat with regard to the first security-bounded tenant. In accordance with this implementation, the association determination logic 1290 configures the entity association information 1296 to indicate that the entity uses the common security vulnerability to initiate the security threat with regard to the first security-bounded tenant. In further accordance with this aspect, determining that the entity attempts to access the second security-bounded tenant at step 704 includes determining that the entity attempts to use the common security vulnerability to access the second security-bounded tenant. In an example implementation, the access determination logic 1292 analyzes the entity association information 1296 to determine that the entity attempts to use the common security vulnerability to access the second security-bounded tenant. In accordance with this implementation, the access determination logic 1292 configures the entity access information 1298 to indicate that the entity attempts to use the common security vulnerability to access the second security-bounded tenant. In further accordance with this aspect, the second security data is analyzed at step 706 as a result of determining that the entity attempts to use the common security vulnerability to access the second security-bounded tenant. In an example implementation, the data analysis logic 2194 analyzes the second security data 1224 as a result of the entity access information 1298 indicating that the entity attempts to use the common security vulnerability to access the second security-bounded tenant.

The threat analysis logic 838 shown in FIG. 8, including any one or more components thereof, may be implemented using artificial intelligence (AI). AI is intelligence of a machine (e.g., a computing system) and/or code (e.g., software and/or firmware), as opposed to intelligence of a living creature (e.g., a human). An AI model is a model that utilizes AI to generate an answer that is responsive to an AI prompt (a.k.a. prompt) that is received by the AI model. The AI model may be an artificial general intelligence model. An artificial general intelligence model is an AI model (e.g., an autonomous AI model) that is configured to be capable of performing any task that an intelligent being (e.g., a human) is capable of performing. In an example implementation, the artificial general intelligence model is capable of performing a task that surpasses the capabilities of an animal.

An AI prompt indicates (e.g., specifies) a task that is to be performed by an AI model. Examples of an AI prompt include but are not limited to a zero-shot prompt, a one-shot prompt, and a few-shot prompt. A zero-shot prompt is a prompt for which the prompt and/or its corresponding contextual information, which are to be processed by the AI model, is not included in pre-trained knowledge of the AI model. A one-shot prompt is a prompt that includes a target prompt along with a single example prompt and a single example answer that is responsive to the single example prompt. The example prompt and the example answer provide guidance as to how the AI model is expected to respond to the target prompt. A few-shot prompt is a prompt that includes a target prompt along with multiple example prompts and multiple example answers that are responsive to the respective example prompts. The example prompts and the example answers provide guidance as to how the AI model is expected to respond to the target prompt.

An AI prompt may be a natural language prompt. A natural language prompt is a prompt that is written in a natural language. A natural language is a human language that has developed through use and repetition. For instance, the natural language may have developed naturally without conscious planning or premeditation. Examples of a natural language include English, French, Spanish, and Mandarin. In an aspect, the natural language prompt is generated by a user (e.g., a human). In another aspect, the natural language prompt is generated by a computing system (e.g., an AI assistant that runs on the computing system).

An AI prompt may not be written in a natural language. For instance, the AI prompt may include (e.g., be) computer code. The AI prompt may be any suitable sequence of characters that is capable of being interpreted by an AI model.

In an example AI embodiment, the threat analysis logic 838 includes (e.g., is) an AI model that is configured to analyze (e.g., develop and/or refine an understanding of) the first security data 814 and the second security data 824, relationships between any of the foregoing, and confidences in those relationships. For example, the threat analysis logic 838 is configured to compare (e.g., correlate) attributes of the first security data 814, the second security data 824, and contextual information (which may include sample first security data associated with the first security-bounded tenant and sample second security data associated with the second security-bounded tenant) using artificial intelligence to perform the cross-tenant security threat analysis (e.g., to identify the security threat with regard to the first security-bounded tenant and/or the second security-bounded tenant) at step 208 shown in FIG. 2.

In an aspect of the AI embodiment, the threat analysis logic 838 classifies the security threat among a plurality of security threat types for purposes of facilitating a determination of the security action that is to be performed at step 212 shown in FIG. 2. For instance, the plurality of security threat types may include a first security threat type corresponding to a first security action, a second security threat type corresponding to a second security action, and so on. The threat analysis logic 838 may classify the security threat among the plurality of security threat types using any suitable classification technique(s). Examples of a classification technique include but are not limited to a logistic regression technique, a decision tree technique, a random forest technique, a support vector machines (SVM) technique, a naïve Bayes technique, a k-nearest neighbors (k-NN) technique, a neural network technique, a gradient boosting machines (GBM) technique, an AdaBoost technique, and an XGBoost technique.

A logistic regression technique is a classification technique that estimates the probability that a given input belongs to a certain class. The logistic regression technique uses the logistic (i.e., sigmoid) function to map predicted values to probabilities between 0 and 1, fitting the data with a linear decision boundary.

A decision tree technique is a classification technique that generates a decision tree by splitting data into subsets based on feature values. Each internal node of the decision tree represents a feature; each branch represents a decision rule; and each leaf node represents an outcome.

A random forest technique is a classification technique in which multiple decision trees are built during training, and the class that is the mode of the classes (classification) or the mean prediction (regression) of the individual trees is provided as an output. The random forest technique reduces overfitting by averaging multiple trees.

An SVM technique is a classification technique in which a hyperplane or a set of hyperplanes is constructed in a high-dimensional space to separate different classes with maximum margin. The best hyperplane is the one that maximizes the distance (i.e., margin) between the nearest points (i.e., support vectors) of the different classes.

A naïve Bayes technique is a classification technique that uses a probabilistic classifier based on Bayes' theorem with strong (i.e., naïve) independence assumptions between the features. The naïve Bayes technique calculates the posterior probability for each class and assigns the class with the highest posterior probability to the instance.

A k-nearest neighbors technique is a non-parametric classification technique that measures the distance between a query point and a set of labeled points, using a majority vote of the query point’s k nearest neighbors to determine the class into which the query point is to be classified. The k-nearest neighbors technique may use any suitable distance metrics (e.g., Euclidean, Manhattan, or cosine similarity).

A neural network technique is a classification technique that uses models, which include layers of interconnected nodes (a.k.a. neurons), to perform classification. Each connection has a weight that adjusts as learning proceeds. Nodes are arranged in layers: input, hidden, and output. Learning is performed in the neural network technique by adjusting weights to minimize error of predictions.

A GBM technique is an iterative classification technique that combines weak learners (e.g., decision trees) such that each subsequent learner attempts to correct the errors of the previous learner(s), optimized by a gradient descent algorithm.

An AdaBoost technique is a classification technique that combines multiple weak classifiers such that each subsequent classifier focuses on instances that were misclassified by previous classifier(s). For instance, weights of instances that are misclassified by a classifier may be adjusted (e.g., increased) to enable subsequent classifier(s) to focus more on those instances.

An XGBoost technique is a classification technique that uses an enhanced gradient boosting algorithm optimized for speed and performance, implementing parallel processing, tree pruning, and handling missing values. Efficiency of the XGBoost technique may be more evident with relatively large datasets.

In some example embodiments, the threat analysis logic 838 includes a neural network that uses the artificial intelligence to determine (e.g., predict) relationships between at least a subset of its inputs (e.g., the first security data 814 and the second security data 824), contextual information that includes context regarding the inputs, and confidences in the relationships. The neural network uses those relationships to generate a corresponding output. For example, attributes of the inputs and potentially example inputs may be compared to determine similarities and differences between those attributes. In accordance with this example, the neural network may use those similarities and differences to determine corresponding AI response(s). In an aspect, the threat analysis logic 838 includes a neural network that uses relationships between the first security data 814 and the second security data 824 to perform the cross-tenant security threat analysis at step 208 shown in FIG. 2 and/or to determine whether the cross-tenant security threat analysis indicates (e.g., results in identification of) a security threat with regard to the first security-bounded tenant and/or the second security-bounded tenant at step 210 shown in FIG. 2.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the threat analysis logic 838 employs a feed forward neural network to train an AI model that is used to determine AI-based confidences. Such AI-based confidences may be used to determine likelihoods that events will occur.

A transformer-based neural network is a neural network that incorporates a transformer. A transformer is a deep learning model that utilizes attention to differentially weight the significance of each portion of sequential input data, such as natural language. Attention is a technique that mimics cognitive attention. Cognitive attention is a behavioral and cognitive process of selectively concentrating on a discrete aspect of information while ignoring other perceivable aspects of the information. Accordingly, the transformer uses the attention to enhance some portions of the input data while diminishing other portions. The transformer determines which portions of the input data to enhance and which portions of the input data to diminish based on the context of each portion. For instance, the transformer may be trained to identify the context of each portion using any suitable technique, such as gradient descent. In an aspect of the example AI embodiment, the transformer-based neural network generates an security threat model (e.g., to identify security threat(s) with regard to tenant(s)) by utilizing information, such as the first security data, the second security data, contextual information, relationships between any of the foregoing, and AI-based confidences that are derived therefrom.

In some example embodiments, the threat analysis logic 838 includes training logic and inference logic. The training logic is configured to train an AI algorithm that the inference logic uses to determine (e.g., infer) the AI-based confidences. For instance, the training logic may provide sample first security data associated with the first security-bounded tenant and sample second security data associated with the second security-bounded tenant as inputs to the AI algorithm to train the AI algorithm. The sample data may be labeled. The AI algorithm may be configured to derive relationships between the features (e.g., the first security data 814 and the second security data 824) and the resulting AI-based confidences. The inference logic is configured to utilize the AI algorithm, which is trained by the training logic, to determine the AI-based confidence when the features are provided as inputs to the algorithm.

In an example generative language model embodiment, the threat analysis logic 838 includes (e.g., is) a generative language model. A generative language model is an AI model that is capable of generating original text output based on sample data. Examples of a generative language model include but are not limited to a generative pre-trained transformer 3 (a.k.a., GPT-3®) model and a generative pre-trained transformer 4 (a.k.a. GPT-4®) model, developed and distributed by OpenAI, Inc.; a large language model Meta AI (a.k.a. LLaMA®) model, developed and distributed by Meta Platforms Inc.; a language model for dialogue applications (a.k.a., LaMDA®) model and a Gemini® model, developed and distributed by Google LLC; and a BigScience large open-science open-access multilingual language model (a.k.a. BLOOM) model, developed and distributed by the BigScience collaborative initiative. A generative language model may use any suitable relevancy determination and/or ranking technique. For instance, the generative language model may use a BM25 (a.k.a. Okapi BM25) ranking function to perform its analysis (e.g., based on keywords).

In an example LLM embodiment, the threat analysis logic 838 includes a large language model (LLM). A large language model is an artificial neural network that is capable of performing natural language processing (NLP) tasks. For instance, the large language model may use a transformer model to perform the NLP tasks. In an aspect, the large language model is trained (e.g., pre-trained) using self-supervised learning and semi-supervised learning. Examples of a large language model include but are not limited to the GPT-3® and GPT-4® models, developed and distributed by OpenAI, Inc.; the LLaMA® model, developed and distributed by Meta Platforms Inc.; and a pathways language model (a.k.a., PaLM®) model and the Gemini® model, developed and distributed by Google LLC.

In an example embedding embodiment, the threat analysis logic 838 includes an embedding model. An embedding model is an AI model that uses deep learning to convert data into vectors (a.k.a. feature vectors or embeddings), which represent attributes of the data, and that compares at least a subset of the vectors to determine an extent to which the vectors that are included in the subset are similar. For instance, each vector may represent a semantic meaning of one or more data items (e.g., one or more data items in the first security data 814 and/or one or more security items in the second security data 824). A vector that represents multiple items (e.g., multiple data items from the first security data 814 and/or the second security data 824) may be a combination (e.g., average or median) of respective vectors of the items. The embedding model may be an encoder-only model, a decoder-only model, or an encoder-decoder model. One example of an encoder-only model is the bidirectional encoder representations from transformers (BERT™) model, which is developed and distributed by Google LLC. One example of an encoder-decoder model is the FLAN-T5™ model, which is developed and distributed by Google LLC.

In an aspect of the embedding embodiment, the threat analysis logic 838 analyzes the first security data 814 and/or the second security data 824 by embedding the first security data 814 (e.g., data items in the first security data 814) to generate one or more first feature vectors and/or by embedding the second security data 824 (e.g., data items in the second security data 824) to generate one or more second feature vectors. A feature vector that represents multiple data items may be a combination (e.g., average or median) of respective feature vectors of the data items. It will be recognized that any one or more of the first feature vector(s) and any one or more of the second feature vector(s) may be combined to create combined feature vector(s). In an example, the first feature vector(s), the second feature vector(s), and the combined feature vector(s) may be fixed length feature vectors having a common (e.g., same) fixed length. The threat analysis logic 838 may compare at least a subset of the first feature vector(s) (a.k.a. first embedding(s)), at least a subset of the second feature vector(s) (a.k.a. second embedding(s)), and/or at least a subset of the combined feature vector(s) (a.k.a. combined embedding(s)) to determine distances therebetween.

A distance between feature vectors, FV1 and FV2, corresponds to a strength of a relationship (e.g., similarity) between the feature vectors. For instance, the distance being relatively shorter indicates that data item(s) from which FV1 is derived correspond to data item(s) from which FV2 is derived to a relatively greater extent, whereas the distance being relatively longer indicates that the data item(s) from which FV1 is derived correspond to the data item(s) from which FV2 is derived to a relatively lesser extent.

The distance between the feature vectors, FV1 and FV2, may be any suitable type of distance, including but not limited to a Euclidian distance (a.k.a. Pythagorean distance), a Manhattan distance, or a Cosine distance. A Euclidian distance between two vectors is the length of the shortest line between the vectors. For example, the Euclidian distance, D_{E}, between two 2-dimensional vectors (a, b) and (x, y) may be represented as D_{E} = [(a - x)^2 + (b - y)^2]^(1/2). In another example, the Euclidian distance, D_{E}, between two 3-dimensional vectors (a, b, c) and (x, y, z) may be represented as D_{E} = [(a - x)^2 + (b - y)^2 + (c - z)^2]^(1/2). A Manhattan distance between two vectors is a sum of absolute differences between corresponding components of the vectors. For example, the Manhattan distance, D_{M}, between two 2-dimensional vectors (a, b) and (x, y) may be represented as D_{M} = Abs(a – x) + Abs(b – y). In another example, the Manhattan distance, D_{M}, between two 3-dimensional vectors (a, b, c) and (x, y, z) may be represented as D_{M} = Abs(a – x) + Abs(b – y) + Abs(c – z). A Cosine distance between two vectors is equal to a dot product of the vectors divided by a product of the magnitudes of the vectors. Accordingly, the Cosine distance, D_{C}, between vectors X and Y may be represented as D_{C} = (X · Y) / (||X|| * ||Y||).

In an example multi-model embodiment, the threat analysis logic 838 includes multiple types of AI models. Weights may be applied to the responses generated by the respective types of AI models. For example, the threat analysis logic 838 may include a generative AI model and an embedding model. In accordance with this example, a first weight may be applied to a first response generated by the generative AI model to provide a first weighted response, and a second weight that is different from the first weight may be applied to a second response of the embedding model to provide a second weighted response. The threat analysis logic 838 may combine (e.g., sum) the first weighted response and the second weighted response to generate a respective output (e.g., AI response).

In an example graph RAG embodiment, the threat analysis logic 838 performs the cross-tenant security threat analysis at step 208 shown in FIG. 2 using a graph retrieval-augmented generation (RAG) technique. A graph RAG technique is a technique that combines knowledge graph(s) with large language model(s) to increase relevance (e.g., accuracy, precision, and/or reliability) of response(s) generated by the large language model(s). A knowledge graph is a structured representation of information that includes nodes and edges. The nodes represent entities (e.g., people, places, or concepts). The edges represent relationships between subsets (e.g., pairs) of the nodes. In accordance with the graph RAG embodiment, the nodes represent identities and resources in the first and second security-bounded tenants, and the edges represent relationships between the identities and resources. In an aspect, the graph retrieval-augmented generation technique takes into consideration hierarchical relationships among the identities and resources.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the cross-tenant security threat analyzer 108, the cross-tenant security threat analyzer 808, the data gathering logic 832, the first storing logic 834, the second storing logic 836, the threat analysis logic 838, the security action logic 840, the tenant association logic 842, and/or the identifier defining logic 844, the threat analysis logic 1100, the security determination logic 1184, the security comparison logic 1186, the threat analysis logic 1200, the association determination logic 1290, the access determination logic 1292, the data analysis logic 1294, flowchart 200, flowchart 300, flowchart 400, flowchart 500, flowchart 600, and/or flowchart 700 may be implemented in hardware, software, firmware, or any combination thereof.

For example, any one or more of the cross-tenant security threat analyzer 108, the cross-tenant security threat analyzer 808, the data gathering logic 832, the first storing logic 834, the second storing logic 836, the threat analysis logic 838, the security action logic 840, the tenant association logic 842, and/or the identifier defining logic 844, the threat analysis logic 1100, the security determination logic 1184, the security comparison logic 1186, the threat analysis logic 1200, the association determination logic 1290, the access determination logic 1292, the data analysis logic 1294, flowchart 200, flowchart 300, flowchart 400, flowchart 500, flowchart 600, and/or flowchart 700 may be implemented, at least in part, as computer program code configured to be executed in one or more processors.

In another example, any one or more of the cross-tenant security threat analyzer 108, the cross-tenant security threat analyzer 808, the data gathering logic 832, the first storing logic 834, the second storing logic 836, the threat analysis logic 838, the security action logic 840, the tenant association logic 842, and/or the identifier defining logic 844, the threat analysis logic 1100, the security determination logic 1184, the security comparison logic 1186, the threat analysis logic 1200, the association determination logic 1290, the access determination logic 1292, the data analysis logic 1294, flowchart 200, flowchart 300, flowchart 400, flowchart 500, flowchart 600, and/or flowchart 700 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

II. Further Discussion of Some Example Embodiments

(A1) An example system (FIG. 1, 102A-102M, 106A-106N; FIG. 8, 800; FIG. 13, 1300) comprises a processor system (FIG. 13, 1302) and a memory (FIG. 13, 1304, 1308, 1310) that stores computer-executable instructions. The computer-executable instructions are executable by the processor system to at least gather (FIG. 2, 202) first security data (FIG. 1, 114, FIG. 8, 814; FIG. 9, 914; FIG. 10, 1014; FIG. 11, 1114; FIG. 12, 1214) from a first resource (FIG. 1, 112) in a first security-bounded tenant (FIG. 1, 110, FIG. 10, 1010) and second security data (FIG. 1, 124, FIG. 8, 824; FIG. 9, 924; FIG. 10, 1024; FIG. 11, 1124; FIG. 12, 1214) from a second resource (FIG. 1, 122) in a second security-bounded tenant (FIG. 1, 120, FIG. 10, 1020). The computer-executable instructions are executable by the processor system further to at least, as a result of the first security data being gathered, store (FIG. 2, 204) the first security data in a tenant-shared store (FIG. 1, 116; FIG. 8, 816; FIG. 9, 900) associated with a unified security account using a first tenant-specific identifier (FIG. 8, 852) associated with the first security-bounded tenant. The computer-executable instructions are executable by the processor system further to at least, as a result of the second security data being gathered, store (FIG. 2, 206) the second security data in the tenant-shared store using a second tenant-specific identifier (FIG. 8, 862) associated with the second security-bounded tenant. The computer-executable instructions are executable by the processor system further to at least perform (FIG. 2, 208) a cross-tenant security threat analysis with regard to the first security-bounded tenant and the second security-bounded tenant by using a multi-tenant identifier (FIG. 8, 850) associated with the unified security account to obtain multi-tenant permission to access the first security data and the second security data in the tenant-shared store. The computer-executable instructions are executable by the processor system further to at least, as a result of the cross-tenant security threat analysis indicating a security threat with regard to at least one of the first security-bounded tenant or the second security-bounded tenant, trigger (FIG. 2, 212) execution of an instruction, which causes a security action (FIG. 8, 858) to be performed with regard to at least one of the first security-bounded tenant or the second security-bounded tenant.

(A2) In the example system of A1, wherein a first instance of a multi-tenant application is configured to execute in the first security-bounded tenant; wherein a second instance of the multi-tenant application is configured to execute in the second security-bounded tenant; wherein the computer-executable instructions are executable by the processor system to at least: determine that the first instance of the multi-tenant application, which executes in the first security-bounded tenant, accesses data that is stored in the second security-bounded tenant; and as a result of a determination that the first instance of the multi-tenant application accesses the data that is stored in the second security-bounded tenant, trigger the execution of the instruction, which causes the security action to be performed with regard to at least one of the first security-bounded tenant or the second security-bounded tenant.

(A3) In the example system of any of A1-A2, wherein the computer-executable instructions are executable by the processor system to at least: determine that a first security policy that is applicable to the first security-bounded tenant provides a first amount of security with regard to the first security-bounded tenant; determine that a second security policy that is applicable to the second security-bounded tenant provides a second amount of security with regard to the second security-bounded tenant; determine that the first amount of security is less than the second amount of security; and as a result of the first amount of security being less than the second amount of security indicating the security threat with regard to the first security-bounded tenant, trigger the execution of the instruction, which causes the security action to be performed with regard to the first security-bounded tenant, the first security action comprising changing the first security policy to provide the second amount of security with regard to the first security-bounded tenant.

(A4) In the example system of any of A1-A3, wherein the computer-executable instructions are executable by the processor system to at least: determine that a first configuration of the first resource provides a first amount of security with regard to the first resource; determine that a second configuration of the second resource provides a second amount of security with regard to the second resource; determine that the first amount of security is less than the second amount of security; and as a result of the first amount of security being less than the second amount of security indicating the security threat with regard to the first security-bounded tenant, trigger the execution of the instruction, which causes the security action to be performed with regard to the first security-bounded tenant, the first security action comprising changing a configuration of the first resource from the first configuration to the second configuration.

(A5) In the example system of any of A1-A4, wherein the computer-executable instructions are executable by the processor system to at least: identify the security threat with regard to the first security-bounded tenant; and analyze the second security data as a result of the security threat with regard to the first security-bounded tenant being identified.

(A6) In the example system of any of A1-A5, wherein the computer-executable instructions are executable by the processor system to at least: determine that an entity is associated with the security threat with regard to the first security-bounded tenant; in response to a determination that the entity is associated with the security threat, determine that the entity attempts to access the second security-bounded tenant; and analyze the second security data further as a result of a determination that the entity attempts to access the second security-bounded tenant.

(A7) In the example system of any of A1-A6, wherein the computer-executable instructions are executable by the processor system to at least: determine that the entity attempts to access the second security-bounded tenant using a secret that is obtained from the first security-bounded tenant; and analyze the second security data as a result of a determination that the entity attempts to access the second security-bounded tenant using the secret that is obtained from the first security-bounded tenant.

(A8) In the example system of any of A1-A7, wherein the computer-executable instructions are executable by the processor system to at least: determine that the first security-bounded tenant and the second security-bounded tenant have a common security vulnerability; determine that the entity uses the common security vulnerability to initiate the security threat with regard to the first security-bounded tenant; determine that the entity attempts to use the common security vulnerability to access the second security-bounded tenant; and analyze the second security data as a result of a determination that the entity attempts to use the common security vulnerability to access the second security-bounded tenant.

(A9) In the example system of any of A1-A8, wherein the computer-executable instructions are executable by the processor system to at least: store the first security data in a first portion of the tenant-shared store, the first portion located in a first geographical region in which the first security data is generated; and store the second security data in a second portion of the tenant-shared store, the second portion located in a second geographical region in which the second security data is generated.

(A10) In the example system of any of A1-A9, wherein the computer-executable instructions are executable by the processor system to at least: gather a first corpus of security data, which includes the first security data, from the first resource in the first security-bounded tenant and a second corpus of security data, which includes the second security data, from the second resource in the second security-bounded tenant; store the first corpus of security data in the tenant-shared store using the first tenant-specific identifier; store the second corpus of security data in the tenant-shared store using the second tenant-specific identifier; perform the cross-tenant security threat analysis by providing a search query against the tenant-shared store, the search query specifying a data attribute; and in response to the search query, receive the first security data and the second security data, rather than an entirety of the first corpus of security data and an entirety of the second corpus of the security data, as a result of the first security data and the second security data having the data attribute.

(A11) In the example system of any of A1-A10, wherein the computer-executable instructions are executable by the processor system to at least: as a result of the cross-tenant security threat analysis indicating a multi-tenant security threat with regard to the first security-bounded tenant and the second security-bounded tenant, trigger the execution of the instruction, which causes a multi-tenant security action to be performed with regard to the first security-bounded tenant and the second security-bounded tenant.

(A12) In the example system of any of A1-A11, wherein the computer-executable instructions are executable by the processor system further to at least: determine that the first security-bounded tenant is associated with an organization by analyzing first information associated with the first security-bounded tenant; determine that the second security-bounded tenant is associated with the organization by analyzing second information associated with the second security-bounded tenant; and define the multi-tenant identifier to provide the multi-tenant permission to access the first security-bounded tenant and the second security-bounded tenant as a result of a determination that the first security-bounded tenant is associated with the organization and further as a result of a determination that the second security-bounded tenant is associated with the organization.

(A13) In the example system of any of A1-A12, wherein the computer-executable instructions are executable by the processor system to at least: determine that an entity that initiates the cross-tenant security threat analysis has a first role with regard to the first security-bounded tenant and a second role with regard to the second security-bounded tenant; determine that the first role has a first permission that grants access to the first security-bounded tenant; determine that the second role has a second permission that grants access to the second security-bounded tenant; and perform the cross-tenant security threat analysis using the multi-tenant identifier as a result of the multi-tenant permission including the first permission, which grants the entity access to the first security-bounded tenant, and the second permission, which grants the entity access to the second security-bounded tenant.

(A14) In the example system of any of A1-A13, wherein the computer-executable instructions are executable by the processor system to analyze at least one of the first security data or the second security data in the tenant-shared store by performing at least the following: determine that data is exfiltrated from at least one of the first security-bounded tenant or the second security-bounded tenant; and identify the security threat as a result of an amount of the data that is exfiltrated being greater than or equal to an amount threshold.

(A15) In the example system of any of A1-A14, wherein the computer-executable instructions are executable by the processor system to analyze at least one of the first security data or the second security data in the tenant-shared store by performing at least the following: determine that data from at least one of the first security-bounded tenant or the second security-bounded tenant is shared with an entity; and identify the security threat as a result of the data being shared with the entity in a manner that violates a policy.

(A16) In the example system of any of A1-A15, wherein the computer-executable instructions are executable by the processor system to analyze at least one of the first security data or the second security data in the tenant-shared store by performing at least the following: determine that an operation is performed with regard to at least one of the first resource in the first security-bounded tenant or the second resource in the second security-bounded tenant; and identify the security threat as a result of an extent of harm that the operation is capable of causing being greater than or equal to a harm threshold.

(B1) An example method is implemented by a computing system (FIG. 1, 102A-102M, 106A-106N; FIG. 8, 800; FIG. 13, 1300). The method comprises gathering (FIG. 2, 202) first security data (FIG. 1, 114, FIG. 8, 814; FIG. 9, 914; FIG. 10, 1014; FIG. 11, 1114; FIG. 12, 1214) from a first resource (FIG. 1, 112) in a first security-bounded tenant (FIG. 1, 110, FIG. 10, 1010) and second security data (FIG. 1, 124, FIG. 8, 824; FIG. 9, 924; FIG. 10, 1024; FIG. 11, 1124; FIG. 12, 1214) from a second resource (FIG. 1, 122) in a second security-bounded tenant (FIG. 1, 120, FIG. 10, 1020). The method further comprises, as a result of gathering the first security data, storing (FIG. 2, 204) the first security data in a tenant-shared store (FIG. 1, 116; FIG. 8, 816; FIG. 9, 900) associated with a unified security account using a first tenant-specific identifier (FIG. 8, 852) associated with the first security-bounded tenant. The method further comprises, as a result of gathering the second security data, storing (FIG. 2, 206) the second security data in the tenant-shared store using a second tenant-specific identifier (FIG. 8, 862) associated with the second security-bounded tenant. The method further comprises performing (FIG. 2, 208) a cross-tenant security threat analysis with regard to the first security-bounded tenant and the second security-bounded tenant by using a multi-tenant identifier (FIG. 8, 850) associated with the unified security account to obtain multi-tenant permission to access the first security data and the second security data in the tenant-shared store. The method further comprises, as a result of the cross-tenant security threat analysis indicating a security threat with regard to at least one of the first security-bounded tenant or the second security-bounded tenant, triggering (FIG. 2, 212) execution of an instruction, which causes a security action (FIG. 8, 858) to be performed with regard to at least one of the first security-bounded tenant or the second security-bounded tenant.

(B2) In the example method of B1, wherein a first instance of a multi-tenant application executes in the first security-bounded tenant; wherein a second instance of the multi-tenant application executes in the second security-bounded tenant; wherein performing the cross-tenant security threat analysis comprises: determining that the first instance of the multi-tenant application, which executes in the first security-bounded tenant, accesses data that is stored in the second security-bounded tenant; and wherein triggering the execution of the instruction comprises: as a result of determining that the first instance of the multi-tenant application accesses the data that is stored in the second security-bounded tenant, triggering the execution of the instruction, which causes the security action to be performed with regard to at least one of the first security-bounded tenant or the second security-bounded tenant.

(B3) In the example method of any of B1-B2, wherein performing the cross-tenant security threat analysis comprises: determining that a first security policy that is applicable to the first security-bounded tenant provides a first amount of security with regard to the first security-bounded tenant; determining that a second security policy that is applicable to the second security-bounded tenant provides a second amount of security with regard to the second security-bounded tenant; and determining that the first amount of security is less than the second amount of security; and wherein triggering the execution of the instruction comprises: as a result of the first amount of security being less than the second amount of security indicating the security threat with regard to the first security-bounded tenant, triggering the execution of the instruction, which causes the security action to be performed with regard to the first security-bounded tenant, the first security action comprising changing the first security policy to provide the second amount of security with regard to the first security-bounded tenant.

(B4) In the example method of any of B1-B3, wherein performing the cross-tenant security threat analysis comprises: determining that a first configuration of the first resource provides a first amount of security with regard to the first resource; determining that a second configuration of the second resource provides a second amount of security with regard to the second resource; and determining that the first amount of security is less than the second amount of security; and wherein triggering the execution of the instruction comprises: as a result of the first amount of security being less than the second amount of security indicating the security threat with regard to the first security-bounded tenant, triggering the execution of the instruction, which causes the security action to be performed with regard to the first security-bounded tenant, the first security action comprising changing a configuration of the first resource from the first configuration to the second configuration.

(B5) In the example method of any of B1-B4, wherein performing the cross-tenant security threat analysis comprises: identifying the security threat with regard to the first security-bounded tenant; and analyzing the second security data as a result of identifying the security threat with regard to the first security-bounded tenant.

(B6) In the example method of any of B1-B5, wherein performing the cross-tenant security threat analysis comprises: determining that an entity is associated with the security threat with regard to the first security-bounded tenant; in response to determining that the entity is associated with the security threat, determining that the entity attempts to access the second security-bounded tenant; and analyzing the second security data further as a result of determining that the entity attempts to access the second security-bounded tenant.

(B7) In the example method of any of B1-B6, wherein determining that the entity attempts to access the second security-bounded tenant comprises: determining that the entity attempts to access the second security-bounded tenant using a secret that is obtained from the first security-bounded tenant; and wherein analyzing the second security data comprises: analyzing the second security data as a result of determining that the entity attempts to access the second security-bounded tenant using the secret that is obtained from the first security-bounded tenant.

(B8) In the example method of any of B1-B7, wherein performing the cross-tenant security threat analysis comprises: determining that the first security-bounded tenant and the second security-bounded tenant have a common security vulnerability; and determining that the entity uses the common security vulnerability to initiate the security threat with regard to the first security-bounded tenant; wherein determining that the entity attempts to access the second security-bounded tenant comprises: determining that the entity attempts to use the common security vulnerability to access the second security-bounded tenant; and wherein analyzing the second security data comprises: analyzing the second security data as a result of determining that the entity attempts to use the common security vulnerability to access the second security-bounded tenant.

(B9) In the example method of any of B1-B8, wherein storing the first security data in the tenant-shared store comprises: storing the first security data in a first portion of the tenant-shared store, the first portion located in a first geographical region in which the first security data is generated; and wherein storing the second security data in the tenant-shared store comprises: storing the second security data in a second portion of the tenant-shared store, the second portion located in a second geographical region in which the second security data is generated.

(B10) In the example method of any of B1-B9, wherein gathering the first security data and the second security data comprises: gathering a first corpus of security data, which includes the first security data, from the first resource in the first security-bounded tenant and a second corpus of security data, which includes the second security data, from the second resource in the second security-bounded tenant; wherein storing the first security data comprises: storing the first corpus of security data in the tenant-shared store using the first tenant-specific identifier; wherein storing the second security data comprises: storing the second corpus of security data in the tenant-shared store using the second tenant-specific identifier; and wherein performing the cross-tenant security threat analysis comprises: providing a search query against the tenant-shared store, the search query specifying a data attribute; and in response to the search query, receiving the first security data and the second security data, rather than an entirety of the first corpus of security data and an entirety of the second corpus of the security data, as a result of the first security data and the second security data having the data attribute.

(B11) In the example method of any of B1-B10, wherein triggering the execution of the instruction comprises: as a result of the cross-tenant security threat analysis indicating a multi-tenant security threat with regard to the first security-bounded tenant and the second security-bounded tenant, triggering the execution of the instruction, which causes a multi-tenant security action to be performed with regard to the first security-bounded tenant and the second security-bounded tenant.

(B12) In the example method of any of B1-B11, further comprising: determining that the first security-bounded tenant is associated with an organization by analyzing first information associated with the first security-bounded tenant; determining that the second security-bounded tenant is associated with the organization by analyzing second information associated with the second security-bounded tenant; and defining the multi-tenant identifier to provide the multi-tenant permission to access the first security-bounded tenant and the second security-bounded tenant as a result of determining that the first security-bounded tenant is associated with the organization and further as a result of determining that the second security-bounded tenant is associated with the organization.

(B13) In the example method of any of B1-B12, further comprising: determining that an entity that initiates the cross-tenant security threat analysis has a first role with regard to the first security-bounded tenant and a second role with regard to the second security-bounded tenant; determining that the first role has a first permission that grants access to the first security-bounded tenant; and determining that the second role has a second permission that grants access to the second security-bounded tenant; wherein the cross-tenant security threat analysis is performed using the multi-tenant identifier as a result of the multi-tenant permission including the first permission, which grants the entity access to the first security-bounded tenant, and the second permission, which grants the entity access to the second security-bounded tenant.

(B14) In the example method of any of B1-B13, wherein analyzing at least one of the first security data or the second security data in the tenant-shared store comprises: determining that data is exfiltrated from at least one of the first security-bounded tenant or the second security-bounded tenant; and identifying the security threat as a result of an amount of the data that is exfiltrated being greater than or equal to an amount threshold.

(B15) In the example method of any of B1-B14, wherein analyzing at least one of the first security data or the second security data in the tenant-shared store comprises: determining that data from at least one of the first security-bounded tenant or the second security-bounded tenant is shared with an entity; and identifying the security threat as a result of the data being shared with the entity in a manner that violates a policy.

(B16) In the example method of any of B1-B15, wherein analyzing at least one of the first security data or the second security data in the tenant-shared store comprises: determining that an operation is performed with regard to at least one of the first resource in the first security-bounded tenant or the second resource in the second security-bounded tenant; and identifying the security threat as a result of an extent of harm that the operation is capable of causing being greater than or equal to a harm threshold.

(C1) An example computer program product (FIG. 13, 1318, 1322) comprises a computer-readable storage medium having instructions recorded thereon for enabling a processor-based system (FIG. 1, 102A-102M, 106A-106N; FIG. 8, 800; FIG. 13, 1300) to perform operations. The operations comprise gathering (FIG. 2, 202) first security data (FIG. 1, 114, FIG. 8, 814; FIG. 9, 914; FIG. 10, 1014; FIG. 11, 1114; FIG. 12, 1214) from a first resource (FIG. 1, 112) in a first security-bounded tenant (FIG. 1, 110, FIG. 10, 1010) and second security data (FIG. 1, 124, FIG. 8, 824; FIG. 9, 924; FIG. 10, 1024; FIG. 11, 1124; FIG. 12, 1214) from a second resource (FIG. 1, 122) in a second security-bounded tenant (FIG. 1, 120, FIG. 10, 1020). The operations further comprise, as a result of gathering the first security data, storing (FIG. 2, 204) the first security data in a tenant-shared store (FIG. 1, 116; FIG. 8, 816; FIG. 9, 900) associated with a unified security account using a first tenant-specific identifier (FIG. 8, 852) associated with the first security-bounded tenant. The operations further comprise, as a result of gathering the second security data, storing (FIG. 2, 206) the second security data in the tenant-shared store using a second tenant-specific identifier (FIG. 8, 862) associated with the second security-bounded tenant. The operations further comprise performing (FIG. 2, 208) a cross-tenant security threat analysis with regard to the first security-bounded tenant and the second security-bounded tenant by using a multi-tenant identifier (FIG. 8, 850) associated with the unified security account to obtain multi-tenant permission to access the first security data and the second security data in the tenant-shared store. The operations further comprise, as a result of the cross-tenant security threat analysis indicating a security threat with regard to at least one of the first security-bounded tenant or the second security-bounded tenant, triggering (FIG. 2, 212) execution of an instruction, which causes a security action (FIG. 8, 858) to be performed with regard to at least one of the first security-bounded tenant or the second security-bounded tenant.

III. Example Computer System

FIG. 13 depicts an example computer 1300 in which embodiments may be implemented. Any one or more of the client devices 102A-102M and/or any one or more of the servers 106A-106N shown in FIG. 1 and/or the computing system 800 shown in FIG. 8 may be implemented using computer 1300, including one or more features of computer 1300 and/or alternative features. Computer 1300 may be a general-purpose computing device in the form of a conventional personal computer, a mobile computer, or a workstation, for example, or computer 1300 may be a special purpose computing device. The description of computer 1300 provided herein is provided for purposes of illustration, and is not intended to be limiting. Embodiments may be implemented in further types of computer systems, as would be known to persons skilled in the relevant art(s).

As shown in FIG. 13, computer 1300 includes a processor system 1302, a system memory 1304, and a bus 1306 that couples various system components including system memory 1304 to processor system 1302. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random access memory (RAM) 1310. A basic input/output system 1312 (BIOS) is stored in ROM 1308.

Computer 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1330, one or more application programs 1332, other program modules 1334, and program data 1336. Application programs 1332 or program modules 1334 may include, for example, computer program logic for implementing any one or more of (e.g., at least a portion of) the cross-tenant security threat analyzer 108, the cross-tenant security threat analyzer 808, the data gathering logic 832, the first storing logic 834, the second storing logic 836, the threat analysis logic 838, the security action logic 840, the tenant association logic 842, and/or the identifier defining logic 844, the threat analysis logic 1100, the security determination logic 1184, the security comparison logic 1186, the threat analysis logic 1200, the association determination logic 1290, the access determination logic 1292, the data analysis logic 1294, flowchart 200 (including any step of flowchart 200), flowchart 300 (including any step of flowchart 300), flowchart 400 (including any step of flowchart 400), flowchart 500 (including any step of flowchart 500), flowchart 600 (including any step of flowchart 600), and/or flowchart 700 (including any step of flowchart 700), as described herein.

A user may enter commands and information into the computer 1300 through input devices such as keyboard 1338 and pointing device 1340. Other input devices (not shown) may include a microphone, joystick, game pad, satellite dish, scanner, touch screen, camera, accelerometer, gyroscope, or the like. These and other input devices are often connected to the processor system 1302 through a serial port interface 1342 that is coupled to bus 1306, but may be connected by other interfaces, such as a parallel port, game port, or a universal serial bus (USB).

A display device 1344 (e.g., a monitor) is also connected to bus 1306 via an interface, such as a video adapter 1346. In addition to display device 1344, computer 1300 may include other peripheral output devices (not shown) such as speakers and printers.

Computer 1300 is connected to a network 1348 (e.g., the Internet) through a network interface or adapter 1350, a modem 1352, or other means for establishing communications over the network. Modem 1352, which may be internal or external, is connected to bus 1306 via serial port interface 1342.

As used herein, the terms “computer program medium” and “computer-readable storage medium” are used to generally refer to media (e.g., non-transitory media) such as the hard disk associated with hard disk drive 1314, removable magnetic disk 1318, removable optical disk 1322, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 1332 and other program modules 1334) may be stored on the hard disk, magnetic disk, optical disk, ROM, or RAM. Such computer programs may also be received via network interface 1350 or serial port interface 1342. Such computer programs, when executed or loaded by an application, enable computer 1300 to implement features of embodiments discussed herein. Accordingly, such computer programs represent controllers of the computer 1300.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
gather first security data from a first resource in a first security-bounded tenant and second security data from a second resource in a second security-bounded tenant;
as a result of the first security data being gathered, store the first security data in a tenant-shared store associated with a unified security account using a first tenant-specific identifier associated with the first security-bounded tenant;
as a result of the second security data being gathered, store the second security data in the tenant-shared store using a second tenant-specific identifier associated with the second security-bounded tenant;
perform a cross-tenant security threat analysis with regard to the first security-bounded tenant and the second security-bounded tenant by using a multi-tenant identifier associated with the unified security account to obtain multi-tenant permission to access the first security data and the second security data in the tenant-shared store; and
as a result of the cross-tenant security threat analysis indicating a security threat with regard to at least one of the first security-bounded tenant or the second security-bounded tenant, trigger execution of an instruction, which causes a security action to be performed with regard to at least one of the first security-bounded tenant or the second security-bounded tenant.

2. The system of claim 1, wherein the computer-executable instructions are executable by the processor system to at least:
determine that a first security policy that is applicable to the first security-bounded tenant provides a first amount of security with regard to the first security-bounded tenant;
determine that a second security policy that is applicable to the second security-bounded tenant provides a second amount of security with regard to the second security-bounded tenant;
determine that the first amount of security is less than the second amount of security; and
as a result of the first amount of security being less than the second amount of security indicating the security threat with regard to the first security-bounded tenant, trigger the execution of the instruction, which causes the security action to be performed with regard to the first security-bounded tenant, the first security action comprising changing the first security policy to provide the second amount of security with regard to the first security-bounded tenant.

3. The system of claim 1, wherein the computer-executable instructions are executable by the processor system to at least:
identify the security threat with regard to the first security-bounded tenant; and
analyze the second security data as a result of the security threat with regard to the first security-bounded tenant being identified.

4. The system of claim 3, wherein the computer-executable instructions are executable by the processor system to at least:
determine that an entity is associated with the security threat with regard to the first security-bounded tenant;
in response to a determination that the entity is associated with the security threat, determine that the entity attempts to access the second security-bounded tenant; and
analyze the second security data further as a result of a determination that the entity attempts to access the second security-bounded tenant.

5. The system of claim 4, wherein the computer-executable instructions are executable by the processor system to at least:
determine that the entity attempts to access the second security-bounded tenant using a secret that is obtained from the first security-bounded tenant; and
analyze the second security data as a result of a determination that the entity attempts to access the second security-bounded tenant using the secret that is obtained from the first security-bounded tenant.

6. The system of claim 4, wherein the computer-executable instructions are executable by the processor system to at least:
determine that the first security-bounded tenant and the second security-bounded tenant have a common security vulnerability;
determine that the entity uses the common security vulnerability to initiate the security threat with regard to the first security-bounded tenant;
determine that the entity attempts to use the common security vulnerability to access the second security-bounded tenant; and
analyze the second security data as a result of a determination that the entity attempts to use the common security vulnerability to access the second security-bounded tenant.

7. The system of claim 1, wherein the computer-executable instructions are executable by the processor system further to at least:
determine that the first security-bounded tenant is associated with an organization by analyzing first information associated with the first security-bounded tenant;
determine that the second security-bounded tenant is associated with the organization by analyzing second information associated with the second security-bounded tenant; and
define the multi-tenant identifier to provide the multi-tenant permission to access the first security-bounded tenant and the second security-bounded tenant as a result of a determination that the first security-bounded tenant is associated with the organization and further as a result of a determination that the second security-bounded tenant is associated with the organization.

8. The system of claim 1, wherein the computer-executable instructions are executable by the processor system to at least:
determine that an entity that initiates the cross-tenant security threat analysis has a first role with regard to the first security-bounded tenant and a second role with regard to the second security-bounded tenant;
determine that the first role has a first permission that grants access to the first security-bounded tenant;
determine that the second role has a second permission that grants access to the second security-bounded tenant; and
perform the cross-tenant security threat analysis using the multi-tenant identifier as a result of the multi-tenant permission including the first permission, which grants the entity access to the first security-bounded tenant, and the second permission, which grants the entity access to the second security-bounded tenant.

9. The system of claim 1, wherein the computer-executable instructions are executable by the processor system to analyze at least one of the first security data or the second security data in the tenant-shared store by performing at least the following:
determine that data is exfiltrated from at least one of the first security-bounded tenant or the second security-bounded tenant; and
identify the security threat as a result of an amount of the data that is exfiltrated being greater than or equal to an amount threshold.

10. The system of claim 1, wherein the computer-executable instructions are executable by the processor system to analyze at least one of the first security data or the second security data in the tenant-shared store by performing at least the following:
determine that an operation is performed with regard to at least one of the first resource in the first security-bounded tenant or the second resource in the second security-bounded tenant; and
identify the security threat as a result of an extent of harm that the operation is capable of causing being greater than or equal to a harm threshold.

11. A method implemented by a computing system, the method comprising:
gathering first security data from a first resource in a first security-bounded tenant and second security data from a second resource in a second security-bounded tenant;
as a result of gathering the first security data, storing the first security data in a tenant-shared store associated with a unified security account using a first tenant-specific identifier associated with the first security-bounded tenant;
as a result of gathering the second security data, storing the second security data in the tenant-shared store using a second tenant-specific identifier associated with the second security-bounded tenant;
performing a cross-tenant security threat analysis with regard to the first security-bounded tenant and the second security-bounded tenant by using a multi-tenant identifier associated with the unified security account to obtain multi-tenant permission to access the first security data and the second security data in the tenant-shared store; and
as a result of the cross-tenant security threat analysis indicating a security threat with regard to at least one of the first security-bounded tenant or the second security-bounded tenant, triggering execution of an instruction, which causes a security action to be performed with regard to at least one of the first security-bounded tenant or the second security-bounded tenant.

12. The method of claim 11, wherein a first instance of a multi-tenant application executes in the first security-bounded tenant;
wherein a second instance of the multi-tenant application executes in the second security-bounded tenant;
wherein performing the cross-tenant security threat analysis comprises:
determining that the first instance of the multi-tenant application, which executes in the first security-bounded tenant, accesses data that is stored in the second security-bounded tenant; and
wherein triggering the execution of the instruction comprises:
as a result of determining that the first instance of the multi-tenant application accesses the data that is stored in the second security-bounded tenant, triggering the execution of the instruction, which causes the security action to be performed with regard to at least one of the first security-bounded tenant or the second security-bounded tenant.

13. The method of claim 11, wherein performing the cross-tenant security threat analysis comprises:
determining that a first configuration of the first resource provides a first amount of security with regard to the first resource;
determining that a second configuration of the second resource provides a second amount of security with regard to the second resource; and
determining that the first amount of security is less than the second amount of security; and
wherein triggering the execution of the instruction comprises:
as a result of the first amount of security being less than the second amount of security indicating the security threat with regard to the first security-bounded tenant, triggering the execution of the instruction, which causes the security action to be performed with regard to the first security-bounded tenant, the first security action comprising changing a configuration of the first resource from the first configuration to the second configuration.

14. The method of claim 11, wherein performing the cross-tenant security threat analysis comprises:
identifying the security threat with regard to the first security-bounded tenant; and
analyzing the second security data as a result of identifying the security threat with regard to the first security-bounded tenant.

15. The method of claim 11, wherein storing the first security data in the tenant-shared store comprises:
storing the first security data in a first portion of the tenant-shared store, the first portion located in a first geographical region in which the first security data is generated; and
wherein storing the second security data in the tenant-shared store comprises:
storing the second security data in a second portion of the tenant-shared store, the second portion located in a second geographical region in which the second security data is generated.

16. The method of claim 11, wherein gathering the first security data and the second security data comprises:
gathering a first corpus of security data, which includes the first security data, from the first resource in the first security-bounded tenant and a second corpus of security data, which includes the second security data, from the second resource in the second security-bounded tenant;
wherein storing the first security data comprises:
storing the first corpus of security data in the tenant-shared store using the first tenant-specific identifier;
wherein storing the second security data comprises:
storing the second corpus of security data in the tenant-shared store using the second tenant-specific identifier; and
wherein performing the cross-tenant security threat analysis comprises:
providing a search query against the tenant-shared store, the search query specifying a data attribute; and
in response to the search query, receiving the first security data and the second security data, rather than an entirety of the first corpus of security data and an entirety of the second corpus of the security data, as a result of the first security data and the second security data having the data attribute.

17. The method of claim 11, wherein triggering the execution of the instruction comprises:
as a result of the cross-tenant security threat analysis indicating a multi-tenant security threat with regard to the first security-bounded tenant and the second security-bounded tenant, triggering the execution of the instruction, which causes a multi-tenant security action to be performed with regard to the first security-bounded tenant and the second security-bounded tenant.

18. The method of claim 11, further comprising:
determining that an entity that initiates the cross-tenant security threat analysis has a first role with regard to the first security-bounded tenant and a second role with regard to the second security-bounded tenant;
determining that the first role has a first permission that grants access to the first security-bounded tenant; and
determining that the second role has a second permission that grants access to the second security-bounded tenant;
wherein the cross-tenant security threat analysis is performed using the multi-tenant identifier as a result of the multi-tenant permission including the first permission, which grants the entity access to the first security-bounded tenant, and the second permission, which grants the entity access to the second security-bounded tenant.

19. The method of claim 11, wherein analyzing at least one of the first security data or the second security data in the tenant-shared store comprises:
determining that data from at least one of the first security-bounded tenant or the second security-bounded tenant is shared with an entity; and
identifying the security threat as a result of the data being shared with the entity in a manner that violates a policy.

20. A computer program product comprising a computer-readable storage medium having instructions recorded thereon for enabling a processor-based system to perform operations, the operations comprising:
gathering first security data from a first resource in a first security-bounded tenant and second security data from a second resource in a second security-bounded tenant;
as a result of gathering the first security data, storing the first security data in a tenant-shared store associated with a unified security account using a first tenant-specific identifier associated with the first security-bounded tenant;
as a result of gathering the second security data, storing the second security data in the tenant-shared store using a second tenant-specific identifier associated with the second security-bounded tenant;
performing a cross-tenant security threat analysis with regard to the first security-bounded tenant and the second security-bounded tenant by using a multi-tenant identifier associated with the unified security account to obtain multi-tenant permission to access the first security data and the second security data in the tenant-shared store; and
as a result of the cross-tenant security threat analysis indicating a security threat with regard to at least one of the first security-bounded tenant or the second security-bounded tenant, triggering execution of an instruction, which causes a security action to be performed with regard to at least one of the first security-bounded tenant or the second security-bounded tenant.
